(19) United States
(12) Patent Application Publication
(10) Pub. No.: US 2026/0037904 A1
(43) Pub. Date: Feb. 5, 2026

(54) SYSTEMS AND METHODS FOR COMPUTER MODELING AND VISUALIZING ENTITY ATTRIBUTES

(71) Applicant: The PNC Financial Services Group, Inc., Pittsburgh, PA (US)

(72) Inventors: Kimberly Petri LONDON, Pittsburgh, PA (US); John Glenn WILKINSON, III, Gibsonia, PA (US)

(73) Assignee: The PNC Financial Services Group, Inc., Pittsburgh, PA (US)

(21) Appl. No.: 19/345,559

(22) Filed: Sep. 30, 2025

Related U.S. Application Data
(63) Continuation of application No. 19/226,591, filed on Jun. 3, 2025.
Application No. 19/226,591 is a continuation-in-part of application No. 18/921,885, filed on Oct. 21, 2024.
Application No. 18/921,885 is a division of application No. 18/501,194, filed on Nov. 3, 2023, now Pat. No. 12,164,492.
(60) Provisional application No. 63/422,886, filed on Nov. 4, 2022.
(60) Provisional application No. 63/714,638, filed on Oct. 31, 2024.

(51) Int. Cl. G06Q 10/0639

(52) U.S. Cl. CPC G06Q 10/06398

(57) ABSTRACT

At least one processor configured to perform operations including receiving data from a plurality of disparate data sources, the data including a plurality of variables associated a plurality of entities and characteristics of the entities; extracting one or more associations from the data, wherein each of the one or more associations includes one or more probabilistic distributions based on a relationship between the performance metrics and the entities and their positions; generating, based on the associations, a flight index for each of the entities; wherein the flight index is a statistical measure of a likelihood that an entity will leave the organization; generating a performance index to each of the entities; identifying, based on a comparison between the flight index and the performance index, a flight probability the entities being higher than a threshold flight probability; implementing, based on the identification, policy changes in the organization.

### CROSS REFERENCE TO RELATED APPLICATIONS

This application is a continuation in part application that claims the benefit of priority of U.S. patent application Ser. No. 18/921,885, filed Oct. 21, 2024, which is a division of U.S. patent application Ser. No. 18/501,194, filed Nov. 3, 2023, which claims the benefit of U.S. Provisional Patent Application No. 63/422,886, filed on Nov. 4, 2022. This application also claims the benefit of U.S. Provisional Patent Application No. 63/714,638, filed on Oct. 31, 2024. The entire contents of the foregoing are incorporated herein by reference.

### TECHNICAL FIELD

The present disclosure relates generally to systems and methods for computer modeling and visualizing entity attributes. More specifically, and without limitation, this disclosure relates to managing aspects of human resources for the workforce of an organization.

### BACKGROUND

Attracting and retaining talented individuals is crucial to an organization's success. As such, it is important to remove or minimize any impediment, or reasons unrelated to work performance, to the career advancement of its employees, for any reason unrelated to work performance, regardless of an employee's classification.

### SUMMARY

While there has been an increased focus in industry organizations on identifying and retaining top talent, barriers to early promotion often arise, which may prevent certain employees from reaching their full potential within an organization. This can be described as a metaphorical “merit ladder,” in which an employee must climb the rungs of the ladder to reach top levels within an organization. Early-career barriers to advancement may be described as a “broken rung.” If certain talented employees are prevented or delayed in early career advancement, they may be unable to climb the merit ladder as quickly or fully as an employee who faces no initial barriers to promotion, even if both employees have the same talent. This issue may be caused by systemic hurdles in the way an organization is run, or by management within the organization. For example, certain employees may face a barrier at a certain level of advancement. This can be metaphorically represented as a “glass ceiling.” In this situation, an employee, despite their merits and qualifications, is unable to reach certain high levels within an organization. Despite an organization's best efforts, bottlenecks may be created in employee career advancement. Such a bottleneck is often also referred to as a “glass ceiling.”

The concept of the “broken rung” in the context of corporate advancement refers to a “broken” step in the corporate ladder, where there is a significant barrier to career advancement. The term highlights the observation that, despite efforts toward promoting the best talent within an organization, there is a promotion gap where some individuals are promoted from entry-level positions to higher roles, while others are not. The broken rung may be at the first step of management, but it is not so limited. A broken rung, or more than one broken rung, could be an impediment to advancement at any point and can exist for both management and individual contributor roles. For example, the position of the broken rung could be different based on an employee's career level in the organization. Additionally, a broken rung is not static in one location over an employee's career. A broken rung may shift in an employee's metaphorical career ladder over time. This shift may be caused by a number of factors, for example as labor markets shift, when an organization undergoes structural change, and merger and acquisitions at an organization.

A related concept is the “glass ceiling,” which refers to an invisible barrier that prevents some employees from rising to top executive positions, despite having the qualifications and abilities to do so. The “glass ceiling” highlights systemic issues that persist even after individuals have moved past entry-level positions, illustrating the ongoing struggle for some employees in upper management and executive roles.

Leadership in an organization often lack direct insight into the cause of a broken rung or even where within the organization a broken rung has occurred. Leadership in an organization often lacks insight into where glass ceilings or broken rungs are located at different steps in the corporate ladder. There is a need for technological tools to impart this insight to leadership in an organization.

There is a need for technological tools to impart this insight to leadership in an organization and to identify these gaps in promotions and upward mobility for diverse employees. Systemic bias within organizations is pervasive yet often not well understood. And there are no analytical tools to define or address systemic bias in a qualitative or empirical manner. To continue progress in acknowledging, identifying, and addressing systemic bias, there is a need for improved systems that provide information on at least one of the following: current demographic representation within an organization; whether the demographic representation is equal in critical work; whether employees move at a similar rate through a company; differences in termination risk; and future demographic representation based on adjusted promotion, hiring, and termination strategies; managerial performance; and whether an individual's reviews match their true performance. There is a further need for improved systems that provide information to leadership on at least one of the following: top performing employees who have not been given promotional opportunities; managerial oversight quality; and subjectivity in managerial oversight, which may affect or cause inequitable advancement opportunities for employees.

Disclosed herein are systems and methods that generate metrics at given points throughout the employment of an employee and transform those metrics about specific employees in a particular manner by applying inventive principles disclosed herein, in order to systematically identify where barriers to career advancement exist for members of specific or identified groups of individuals characterized by one or more characteristics. The metrics may lead to actions that improve the odds of increased merit-based promotion over time without quotas, objectives, or other constraints on employees. For example, an organization may not be aware that, due to a social or structural barrier, employees of a particular class in a particular business working on similar work as employees in a second business are not being promoted at the same rate as in the first business. Because there are no tools to identify such, the organization may never become aware of this disparity.

Using the systems and methods disclosed herein, an organization may observe metrics generated over time, transform those metrics as described herein, and generate a promotion velocity score for employees engaged in, e.g., similar work performed by employees of a same rank or grade across the organization. Applying the systems and methods described herein, the organization may use those generated scores to identify a source of the disparity.

Further disclosed are systems and methods that generate metrics regarding an employee's overall performance and advancement potential. These metrics may identify employees who exhibit certain preferable performance qualities and may identify certain employees who exhibit certain characteristics of departing from the organization, i.e., employees who present a flight risk. These metrics may enable the organization to make informed decisions, e.g., regarding employee policies and procedures which may improve talent retention.

For example, an organization might not be aware that, due to lack of promotion or barrier to receiving specific types of assignments, certain high performing employees are not being given the same opportunities to engage in specific types of career development activities. Using the systems and methods disclosed herein, an organization may observe metrics generated over time, transform those metrics as described herein, and generate a flight score for high performing employees who have not received, e.g., the same or similar career enhancing work as other employees of a same rank or grade across the organization. Applying the systems and methods described herein, the organization may use those generated scores to identify a source of the disparity in merit-based promotion and to identify employees who present a risk of leaving the organization. Applying the systems and methods described herein, the organization may further use the generated scores to identify a source of the disparity in employee review scores and to identify employees whose performance should be objectively reassessed.

Further disclosed are systems and methods that generate metrics regarding a manager's overall performance and quality of managerial oversight. These metrics may identify managers who exhibit certain negative qualities and may identify certain managers who require additional oversight by leadership.

For example, an organization might not be aware that, due to lack of engagement with their subordinates, a manager is providing inadequate support to their employees. Using the systems and methods disclosed herein, an organization may observe metrics generated over time, transform those metrics as described herein, and generate a manager score to identify managers whose poor leadership presents a risk to the organization. Applying the systems and methods described herein, the organization may use the generated scores to identify a source of disparity and to identify managers whose low quality of work presents a risk to the rest of the organization. These metrics may enable an organization to make informed decisions regarding, e.g., a manager's need for training, removal from the organization, or policy changes to the organization.

Further disclosed are systems and methods that generate metrics regarding inconsistencies between manager evaluations of an employee and other metrics of the employee's performance. These metrics may identify employees who may require an objective review of their performance and may identify managers who are not giving fair reviews to their subordinates. These metrics may enable the organization to make informed decisions regarding, e.g., employee policies, managerial policies, and employment decisions.

For example, an organization might not be aware that, due to biases held by the manager, an employee is receiving unfairly low performance ratings compared to the quality of the employee's work product. Using the systems and methods disclosed herein, an organization may observe metrics generated over time, transform those metrics as described herein, and generate a review inconsistency score to identify employees who are being unfairly held back by their managers. Applying the systems and methods described herein, the organization may use the generated scores to identify a source of the disparity and to identify employees who would be a greater benefit to the organization if their work was objectively reviewed.

In view of the foregoing, embodiments of the present disclosure address disadvantages of existing systems by providing novel computer-implemented systems and methods for (i) identifying and predicting inequality outcomes in a job role, (ii) predicting attrition of employees in a job role, and (iii) predicting the employee composition of an organization within a company over a duration of time, (iv) identifying high-performing employees who present a talent flight risk, (v) identifying low-performing managers who present a risk of poor management of their subordinates, and (vi) identifying employees with inconsistent performance reviews who require an object second review.

Embodiments of the present disclosure provide a non-transitory computer readable medium storing instructions, that, when executed by at least one processor, cause the at least one processor to perform operations for identifying a velocity model for a plurality of positions. For example, a plurality of positions may refer to a plurality of job roles in an organization. The operations may include receiving data from a plurality of disparate data sources, the data including a plurality of variables. Each variable of the plurality of variables may be associated with a data type and an entity of a total plurality of entities.

The operations may include distilling the data into a plurality of indexes to convert the data into the plurality of indexes to be usable by a single data structure by assigning a binary value to each variable of the plurality of variables, wherein each variable is a categorical value, a numerical value, or an ordinal value, by generating, using the binary value of each variable, an index for each data type and each entity of the total plurality of entities and by storing each index in a database. A first set of data elements may be retrieved from the plurality of indexes. The first set of data elements may be associated with a first plurality of entities of the total plurality of entities. A second set of data elements may be retrieved from the plurality of indexes. The second set of data elements may be associated with a second plurality of entities of the total plurality of entities.

The operations may further include generating a predicted duration of time that the first plurality of entities will remain in a first position using the second set of data elements associated with the second plurality of entities. A first velocity index may be assigned to each of the first plurality of entities to obtain a plurality of first velocity indexes. The first velocity index may be directly proportional to a measure of closeness between the predicted duration and the actual duration of time in the position in the first set of data elements. A second velocity index may be assigned to each of the second plurality of entities to obtain a plurality of second velocity index. The second velocity index may be directly proportional to a measure of closeness between the predicted duration and the actual duration of time in the position in the second set of data elements.

The operations may further include comparing each of the first velocity indexes to other first velocity indexes from among the plurality of first velocity indexes. The comparing may include identifying differences between each of the first velocity indexes and identifying information associated with a data category of each of the first plurality of entities. The operations may further include comparing each of the second velocity indexes to other second velocity indexes from among the plurality of second velocity indexes. The comparing may include identifying differences between each of the second velocity indexes and identifying information associated with the data category of each of the second plurality of entities. The operations may further include generating, using the first plurality of velocity indexes and the second plurality of velocity indexes, a velocity model. In some embodiments, the operations may be performed for a plurality of positions.

The operations may further comprise creating a distribution of the velocity indexes that may include the first and second velocity indexes. The operations may further include generating a score associated with an expectation that one or more entities in the first plurality of entities will move to another position and generating, using the score, a quantity of a projected first plurality of entities in the position over a duration of time.

In some embodiments, the operations may include generating a user interface containing information entry fields for receiving user input regarding employee composition and performance input parameters or input datasets and providing the graphical user interface for display on a user device. The operations may also include receiving from the user interface one or more input parameters or one or more input datasets. The operations may further include generating a second projected first plurality of entities in the position over the duration of time based on the one or more input parameters or one or more input datasets.

In some embodiments, the operations described above may include a method for identifying a velocity model for a plurality of positions and predicting outcomes for the plurality of positions (e.g., identifying and predicting inequality outcomes in a job role). In other embodiments, the operations described above may be performed by at least one processor configured to execute instructions in a system for identifying a velocity model for a plurality of positions and predicting outcomes for the plurality of positions.

In some embodiments, a non-transitory computer readable medium storing instructions that, when executed by at least one processor, cause the at least one processor to perform operations for predicting attrition using an attrition index. The operations may include receiving data from a plurality of disparate data sources. The data may include a plurality of variables, wherein each variable of the plurality of variables is associated with a data type and an entity of a plurality of entities in a position. The operations may further include distilling the data into a plurality of indexes. The distilling may convert the data into a plurality of indexes to be usable by a single data structure. The data conversion may be performed by assigning a binary value to each variable of the plurality of variables, wherein each variable is a categorical value, a numerical value, or an ordinal value, by generating, using the binary value of each variable, an index for each data type and each entity of the plurality of entities and by storing each index in a database.

The operations may further include retrieving a set of data elements from the plurality of indexes, wherein the set of data elements may include information associated with the plurality of entities. The set of data elements may include information associated with at least one of: tenure, years in the job role, age, commute distance, performance, and payroll data. An attrition index may be assigned to each of the information or to each of the entities included in the set of data elements. The operations may further comprise predicting, using the attrition index, attrition for each entity of the plurality of entities, wherein the attrition is a binary event.

The operations may further include creating a distribution of attrition for the position, wherein the distribution uses the attrition of each entity of the plurality of entities. The distribution may use the likelihood of attrition of each of the plurality of individuals. The operations may further comprise generating, using the distribution, a quantity of a projected plurality of entities in the position over a duration of time. The operations may further comprise generating a visualization of the distribution.

In some embodiments, the operations described above may be a method for predicting attrition for each entity of the plurality of entities based on an attrition index. In other embodiments, the operations described above may be performed by at least one processor configured to execute instructions in a system for predicting attrition for each entity of the plurality of entities based on an attrition index.

In some embodiments, a non-transitory computer readable medium storing instructions that, when executed by at least one processor, cause the at least one processor to perform operations for predicting the expected composition of entities in a position (e.g., predicting employee composition of an organization within a company) over a duration of time is provided. The operations may include receiving data from a plurality of disparate data sources. The data may include a plurality of variables, wherein each variable of the plurality of variables is associated with a data type and an entity of a plurality of entities in a first position.

The operations may further include distilling the data into a plurality of indexes. The distilling may convert the data into the plurality of indexes to be usable by a single data structure by assigning a binary value to each variable of the plurality of variables, wherein each variable is a categorical value, a numerical value, or an ordinal value, by generating, using the binary value of each variable, an index for each data type and each entity of the plurality of entities and by storing each index in a database.

The operations may include retrieving a first set of data elements associated with the plurality of entities from the plurality of indexes, wherein the first set of data elements includes information associated with a velocity index, attrition, and network analytic index. The first set of data elements may include information associated with a velocity index, social networking score, pay equity score, engagement score, attrition, network analytic index and one or more demographic traits. The operations may include generating a first probability of moving to a first different position for each of the plurality of entities. The first probability may be calculated by a first mathematical transformation that includes the velocity index, attrition, and network analytic index.

The operations may include generating a second probability of moving to a second different position for each of the plurality of entities. The second probability may be calculated by a second mathematical transformation that includes the velocity index, attrition, and network analytic index. The operations may further include predicting a number of second entities. The number of second entities may include a number of entities expected to move to the first position.

The operations may also include generating a second set of data elements associated with a second plurality of entities. The generating may include applying a third mathematical transformation to the first probability, the second probability, and prediction of the number of second entities. The operations may further include generating an expected composition of entities in the first position. The generating may include identifying at least one data category of each of the second plurality of entities.

The operations may further include displaying a visualization of the expected composition. The operations may also include generating a graphical user interface containing information entry fields for receiving user input regarding input parameters or input datasets. The operations may include providing the graphical user interface for display on a user device. The operations may further include receiving, from the graphical user interface via the user device, one or more input parameters or one or more input datasets. The one or more input parameters or one or more input datasets may change one or more of the first probability, the second probability, and the prediction of the number of second entities. The operations may further include generating a second expected composition of entities in the first position based on the one or more input parameters or one or more input datasets. The operations may further include displaying a second visualization of the second expected composition.

In some embodiments, the operations described above may be a method for predicting the employee composition of an organization within a company over a duration of time. In other embodiments, the operations described above may be performed by at least one processor configured to execute instructions in a system for predicting employee composition of an organization within a company over a duration of time.

In some embodiments, the operations described above may include a method for optimizing an organization's outreach, recruitment, work product, affinity groups, retention, employment, contracting, or inclusion program. In other embodiments, the operations described above may be used in various applications to achieve qualitative or quantitative improvement in the employee composition of an organization.

In some embodiments a non-transitory computer readable medium storing instructions that when executed by a processor cause the processor to perform operations that may predict an entity's probability of leaving an organization based on their performance and other data points is disclosed. In some embodiments, the operations may include receiving data from a plurality of disparate data sources, the data including a first and second plurality of variables; wherein a first plurality of variables is associated with one entity of a plurality of entities in a position of a plurality of positions; wherein a second plurality of variables is associated with a performance metric of a plurality of performance metrics associated with the each of the plurality of entities; wherein the plurality of disparate data sources includes at least one of: one or more input datasets, one or more second input datasets, individual performance monitoring, team monitoring, and market monitoring.

In some embodiments, the operations may include generating a plurality of indexes, where the plurality of indexes comprises: a first index associated with the plurality of positions; a second index associated with the plurality of entities; a third index associated with one or more characteristics associated with each of the plurality of entities; and a fourth index associated with the plurality of performance metrics.

In some embodiments, the operations may include storing the plurality of indexes in a database; extracting one or more associations from the plurality of indexes, wherein each of the one or more associations includes one or more probabilistic distributions based on a relationship between each of the plurality of performance metrics and each of the plurality of positions; generating, based on each of the plurality of entities, the associated performance metrics, and the extracted one or more associations, a flight index for each of the entities; wherein the flight index is a statistical measure of a likelihood that the associated entity will change from the associated entity's current position within an organization to one or more new positions outside of the organization; generating, based on each of the plurality of entities and the associated performance metrics, a performance index to each of the entities; comparing the flight index for each of the entities with the performance index of the same entity; and identifying, based on the comparison, a flight probability of one or more chosen entities of the plurality of entities being higher than a threshold flight probability.

In some embodiments, the operations may include implementing, based on the identification, one or more changes to one or more policies of the organization; wherein the one or more changes to one or more policies are configured to reduce the statistical likelihood that the one or more chosen entities will change from a current positions of the one or more chosen entities current position within the organization to one or more new positions outside of the organization; and monitoring, based on the implementation, the flight index of the one or more chosen entities over a period of time. Other embodiments of this aspect include corresponding computer systems, apparatus, and computer programs recorded on one or more computer storage devices, each configured to perform the actions of the methods.

In some embodiments, a non-transitory computer readable medium storing instructions that, when executed by a processor, cause the processor to perform operations that may predict one or more entities in a managerial position who may be managing the employees under them inconsistently or inaccurately. In some embodiments, the operations may include receiving data from a plurality of disparate data sources, the data including a first and second plurality of variables, wherein each of the first plurality of variables is associated with one entity of a plurality of entities in a managerial position of a plurality of managerial positions; wherein each of the second plurality of variables is associated with a performance metric of a plurality of performance metrics associated with each of the plurality of entities; wherein the plurality of disparate data sources includes at least one of: one or more input datasets, one or more second input datasets, individual performance monitoring, team monitoring, and market monitoring.

In some embodiments, the operations may include generating a plurality of indexes, where the plurality of indexes comprises: a first index associated with the plurality of managerial positions; a second index associated with the plurality of entities; and a third index associated with the plurality of performance metrics; storing the plurality of indexes in a database; extracting one or more associations from the plurality of indexes, wherein each of the one or more associations includes one or more probabilistic distributions based on a relationship between each of the plurality of performance metrics and each of the plurality of managerial positions; and identifying, based a comparison between each of the plurality of performance metrics in the third index associated with each of the plurality of entities and the extracted set of one or more associations, one or more outlier entities having a managerial score higher than a threshold.

In some embodiments, the operations may include implementing, based on the identification, one or more changes to one or more policies of an organization, wherein the one or more changes includes at least one or: removing one or more of the outlier entities from the organization, providing additional management training to removing one or more of the outlier entities. Other embodiments of this aspect include corresponding computer systems, apparatus, and computer programs recorded on one or more computer storage devices, each configured to perform the actions of the methods.

The operations may further include retrieving a set of data elements from the plurality of indexes, wherein the set of data elements may include information associated with the plurality of entities. The set of data elements may include information associated with at least one of manager engagement in the organization or organizational initiatives, quality of review feedback provided to employees, employee and management turnover within the organization, a number of employee relationship cases, leadership reviews from mangers and subordinate employees.

In some embodiments, a non-transitory computer readable medium storing instructions that, when executed by a processor cause the processor to perform operations that may predict one or more entities having a performance review that does not match their predicted performance based on collected metrics. In some embodiments, the operations described above may be a method for predicting at least one of employee reviews, employee review inconsistencies, or manager performance for each entity of the plurality of entities based on a manager performance index. In other embodiments, the operations described above may be performed by at least one processor configured to execute instructions in a system for predicting employee performance for each entity of the plurality of entities based on a review discrepancy index. In other embodiments, the operations described above may be performed by at least one processor configured to execute instructions in a system for predicting which entity in the plurality of entities requires a second, objective review. In other embodiments, the operations described above may be performed by at least one processor configured to execute instructions in a system for predicting manager subjectivity in managing employee performance.

In some embodiments, a non-transitory computer readable medium storing instructions that, when executed by a processor cause the processor to perform operations that may predict one or more entities whose predicted performance is lower than a performance recorded by the entity's supervisor.

In some embodiments, the operations may include receiving data from a plurality of disparate data sources, the data including a first, second, third, and fourth plurality of variables, wherein each of the first plurality of variables is associated with one entity of a plurality of entities in a position of a plurality of positions; wherein each of the second plurality of variables is associated with a performance metric of a plurality of performance metrics associated with the each of the plurality of entities; wherein each of the third plurality of variables is associated with one or more review scores associated with each of the plurality of entities; wherein each of the fourth plurality of variables is associated with one or more characteristics of each of the plurality of entities; wherein the plurality of disparate data sources includes at least one of: one or more input datasets, one or more second input datasets, and individual and group performance monitoring.

In some embodiments, the operations may include generating a plurality of indexes, where the plurality of indexes comprises: a first index associated with the plurality of entities; a second index associated with the plurality of performance metrics; a third index associated with the one or more review scores; and a fourth index associated with the one or more characteristics associated with each of the plurality of entities; storing the plurality of indexes in a database; comparing the first index and second index for each of the plurality of entities; extracting one or more associations from the plurality of indexes, wherein each of the one or more associations includes one or more probabilistic distributions based on a relationship between the plurality of indexes; wherein the one or more associations are related to a probabilistic performance score associated with each of the one or more entities.

In some embodiments, the operations may include identifying, based on the extraction and the comparison, a plurality of probabilistic performance scores and associated one or more entities, being higher than the review score associated with the same of the one or more entities; implementing, based on the identification, one or more changes to one or more policies of an organization; wherein the one or more changes to one or more policies are configured to reduce a statistical likelihood that the associated one or more entities will have a mismatched review score and probabilistic review score; monitoring, based on the implementation, the probabilistic review score of the associated one or more entities over a period of time; and distilling, based on the identification and the fourth index, common characteristics shared among the associated one or more entities.

Other embodiments of this aspect include corresponding computer systems, apparatus, and computer programs recorded on one or more computer storage devices, each configured to perform the actions of the methods.

The systems and methods disclosed herein may be used in various applications and business systems. It is to be understood that the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1A illustrates a hypothetical scenario demonstrating the concept of a broken rung in an advancement merit ladder within an organization.

FIG. 1B illustrates a hypothetical scenario demonstrating the concept of a glass ceiling blocking advancement for certain individuals within an organization.

FIG. 1C illustrates receiving data from a plurality of disparate sources, according to embodiments of the present disclosure.

FIG. 1D illustrates a system utilizing the data to identify individuals or entities who may fall into specified categories, according to embodiments of the present disclosure.

FIG. 2A presents a hypothetical scenario demonstrating an organization with people divided up into like-work categories and pay grades where c-level at the top represents identified imbalances in career advancement for people working in similar jobs.

FIG. 2B Illustrates an organization's structural barrier to career advancement.

FIG. 2C Illustrates a technological solution to identifying these impediments to career advancement.

FIG. 3 presents a flowchart illustrating an exemplary method for transformation of data into indexes, according to embodiments of the present disclosure.

FIG. 4 illustrates an exemplary output of indexing in the form of a social network index, according to embodiments of the present disclosure.

FIG. 5 presents a flowchart illustrating an exemplary method of determining the promotion velocity, according to embodiments of the present disclosure.

FIG. 6 presents a flowchart illustrating an exemplary method of identifying differences in demographic traits, according to embodiments of the present disclosure.

FIG. 7A illustrates an example of calculated promotion velocity medians of different demographic groups, according to embodiments of the present disclosure.

FIG. 7B illustrates an example of calculated time spent in a career level of different demographic groups, according to embodiments of the present disclosure.

FIG. 8 presents a flowchart illustrating an exemplary method for determining a likelihood of attrition, according to embodiments of the present disclosure.

FIG. 9 presents a flowchart illustrating an exemplary process of assigning a score, as shown in FIG. 8, according to embodiments of the present disclosure.

FIG. 10 illustrates an output of the attrition model algorithm displaying the attrition risk of individuals in an organization by different demographic groups, according to embodiments of the present disclosure.

FIG. 11 presents a flowchart illustrating an exemplary method for forecasting employee composition, according to embodiments of the present disclosure.

FIG. 12 presents a flowchart illustrating another exemplary method for forecasting employee composition, according to embodiments of the present disclosure.

FIG. 13A illustrates an exemplary output of the employee composition forecasting algorithm showing the present employee composition within a company, according to embodiments of the present disclosure.

FIG. 13B illustrates an exemplary output of the employee composition forecasting algorithm showing a predicted, or expected, composition of employees within a company, according to embodiments of the present disclosure.

FIG. 14 illustrates an example of a system configured to perform functions of the disclosed embodiments.

FIG. 15A illustrates an exemplary output of the employee composition forecasting algorithm showing present employee composition of career levels within a company, according to embodiments of the present disclosure.

FIG. 15B illustrates an exemplary output of the employee composition forecasting algorithm showing present composition of the top 15 job families in a company, according to embodiments of the present disclosure.

FIG. 16 illustrates an exemplary output of the employee composition forecasting algorithm showing the present composition of new hires by on career level, according to embodiments of the present disclosure.

FIG. 17 illustrates an exemplary output of the employee composition forecasting algorithm showing the composition of annual terminations by career level, according to embodiments of the present disclosure.

FIG. 18 illustrates an exemplary transformation of the data that can be presented to a user via a user display, according to embodiments of the present disclosure.

FIG. 19 illustrates the exemplary flow of transformed data, according to embodiments of the present disclosure.

FIG. 20 illustrates a flow chart showing the attrition profile for a plurality of individuals, according to embodiments of the present disclosure.

FIG. 21 illustrates a flow chart showing the talent flight risk profile for a plurality of individuals, according to embodiments of the present disclosure.

FIG. 22 illustrates a flow chart showing the manager score for a plurality of individuals, according to embodiments of the present disclosure.

FIG. 23 illustrates a flow chart showing the review inconsistency score for a plurality of individuals, according to embodiments of the present disclosure.

### DETAILED DESCRIPTION

Reference will now be made in detail to exemplary embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the scope of the disclosed embodiments. Similarly, additional steps may be added or steps may be removed without departing from the scope of the disclosed embodiments. Thus, the materials, methods, and examples are illustrative only and are not intended to be limiting.

As used herein, an organization may pertain to a team within a company, a business unit within a company, a branch of a company, a location of a company (wherein the company has multiple locations), or any other organized body of individuals with a shared purpose and/or location.

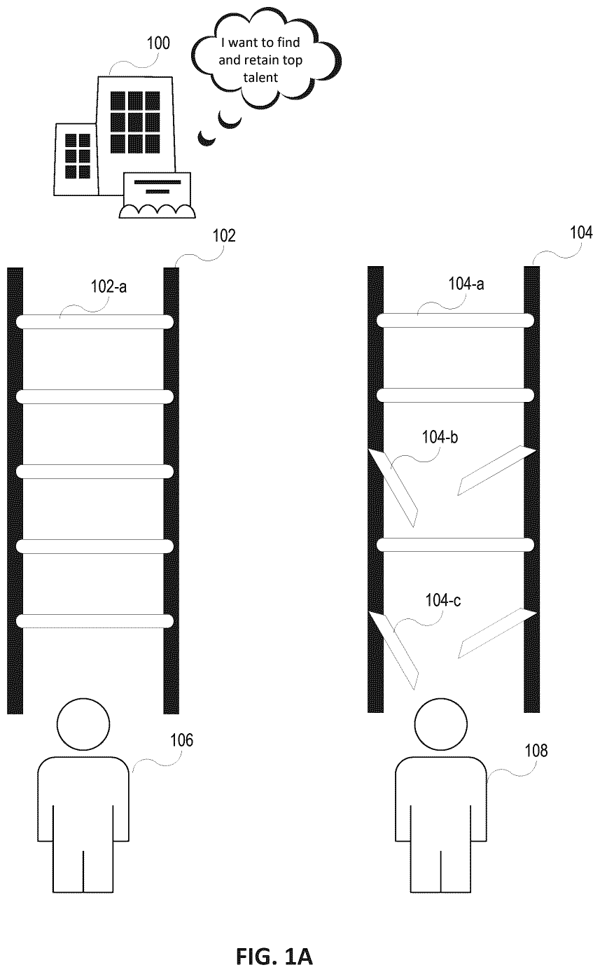

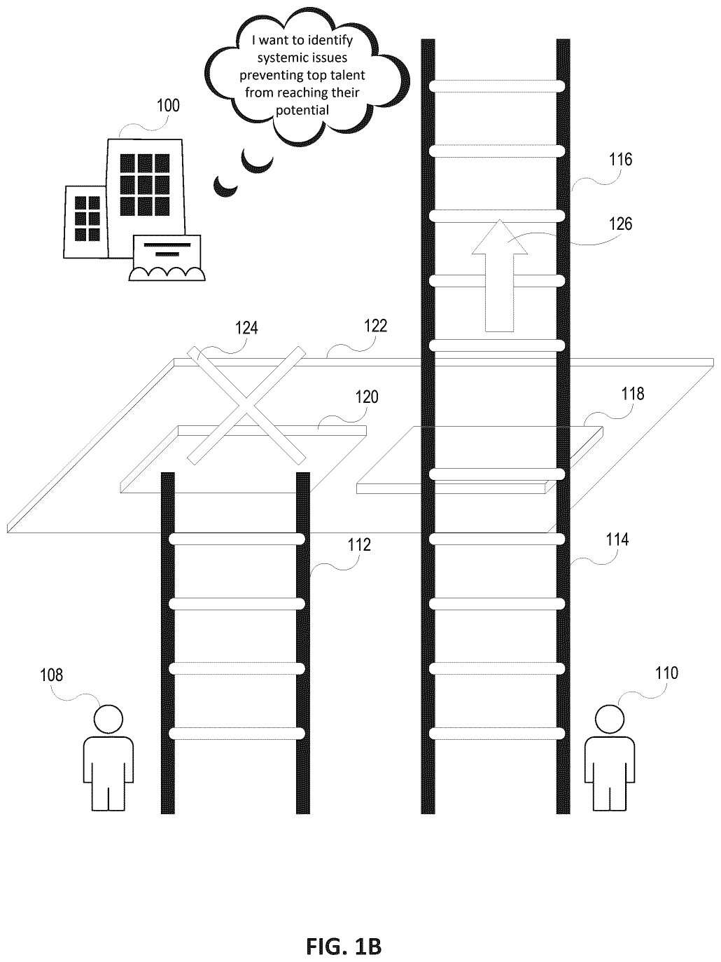

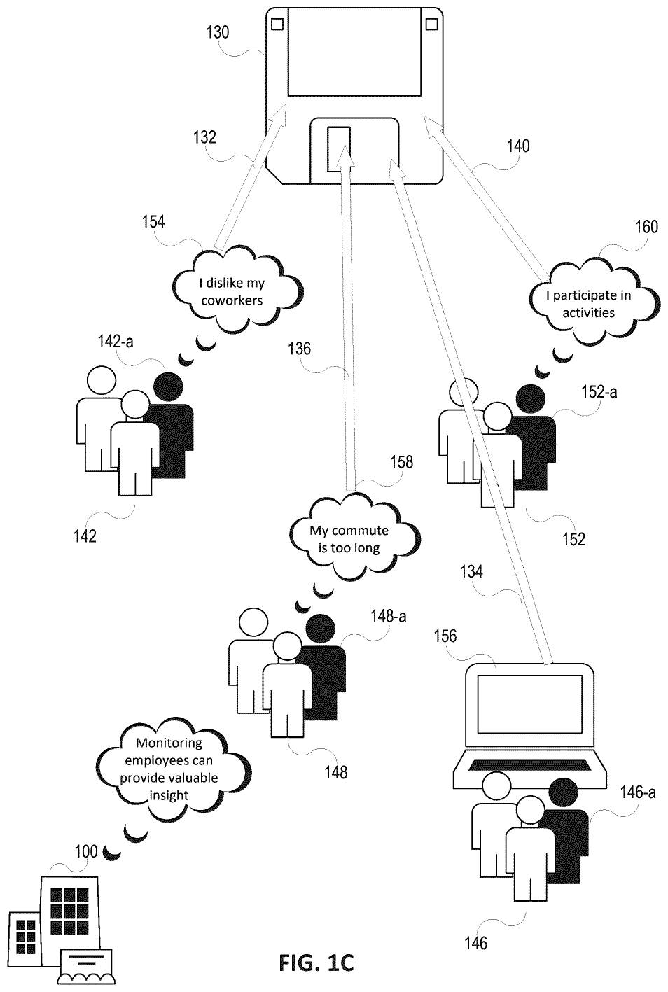

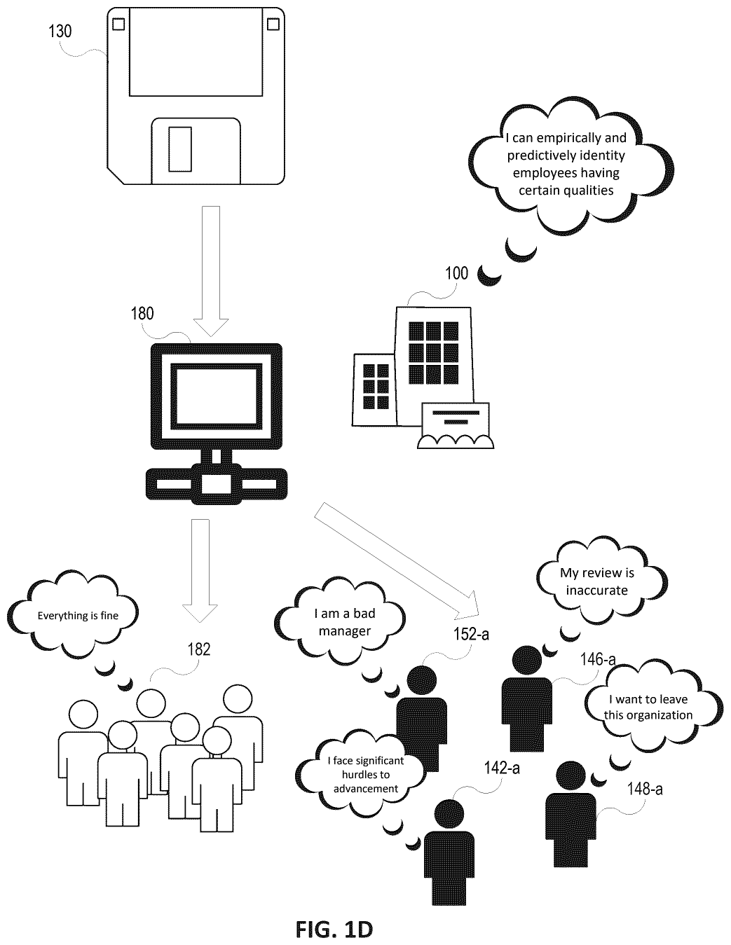

Reference is now made to FIG. 1A, which illustrates a hypothetical scenario demonstrating the concept of a broken rung in the corporate merit ladder that may prevent employees belonging to a group or having a shared characteristic from reaching a higher level of advancement within an organization. For example, organization 100 may desire to identify and retain top talent or top performing employees in the organization. However, systemic and pervasive biases or barriers may prevent some employees from advancing within the organization and thus prevent the employees from reaching their fullest potential. Additionally, systemic and pervasive bias may encourage talented employees to leave an organization if the employees feel that their needs are not being addressed or if they feel like their talents are unappreciated at their current organization.

For example, traditional employee 106 faces intact ladder 102, where the intact ladder 102 comprises a plurality of unbroken rungs 102-a. Each rung of the intact ladder 102 may represent a managerial level within an organization, for example, entry level, manager, senior managing director, vice president, senior president, and c-suite. An employee starting at an organization enters at the bottom of the ladder and must climb through the ranks to advance in managerial roles. Because intact ladder 102 has unbroken rungs 102-a, employee 106 may be capable of climbing intact ladder 102 to higher advancement levels within an organization based on the employee's 106 potential and capability alone.

Intact ladder 102 is contrasted with broken ladder 104. For example, broken ladder 104 may comprise a plurality of unbroken runs 104-a and a plurality of broken rungs 104-b and 104-c. First broken rung 104-c is the first rung on the ladder, illustrating the first barrier to entry experienced by identified employee 108. In this way, broken rungs 104-b and 104-c may represent barriers to initial advancements within managerial roles at an organization. Additionally, broken rungs 104-b and 104-c may represent a shifting broken rung that changes over the course of an employee's career, as described above. For example, when the identified employee 108 reaches over the first broken run 104-c, they may then advance on unbroken run 104-a. However, the identified employee 108 may face additional advancement hurdles, for example second broken rung 104-b. Over the course of their career, the identified employee 108 may be unable to reach the same level of advancement within the organization even though they have the same skills as traditional employee 106 due to the plurality of broken rungs 104-b and 104-c.

Reference is now made to FIG. 1B, which represents the concept of the glass ceiling that may prevent advancement of one or more identified employees 108 from reaching higher levels of management within an organization. For example, organization 100 may desire to retain top talent and encourage top talent to reach their full potential within an organization. However, systemic and pervasive bias may prevent some employees from reaching top positions within the organization and thus prevent the employees from reaching their fullest potential. Additionally, systemic and pervasive bias may encourage talented employees to leave an organization if the employees feel that their needs are not being addressed or if they feel like their talents are unappreciated at their current organization. Glass ceiling 122 may represent a social barrier preventing employees 108, those employees belonging to a certain group of people or sharing one or more characteristics, from being promoted to top jobs in management. The concept of a glass ceiling refers to the corporate hierarchy and how invisible barriers seemed to prevent some employees from advancing in their careers past a certain level based on characteristics associated with the employees other than the employees' merits.

Traditional employee 110 is tasked with climbing a first corporate ladder 114. The traditional corporate ladder 114 passes through the window 118 in glass ceiling 122 to upper management ladder 116. Thus, by traditional employee's skills, traditional employee 110 may be able to climb upwards 126 to upper management ladder 116 and thus to higher levels of advancement within an organization.

This is contrasted with identified employee 108, who faces barrier 120 in glass ceiling 122. Therefore, identified employee 108 is blocked 124 from advancing up ladder 112 beyond the level of glass ceiling 120. There have been substantial invisible barriers for them to reach high-level management positions such as lack of social capital, low level of self-efficacy and self-esteem, stereotypes, and organizational culture. Organization efforts are needed to break double glass ceilings and to confront workplace biases and limitation of access to resources and opportunities rooted in the workplace.

Reference is now made to FIG. 1C, which illustrates a database 130 receiving data from a plurality of disparate sources, according to embodiments of the present disclosure.

According to some embodiments, organization 100 may utilize data collected from a plurality of disparate data sources to monitor employees and create predictions about the composition of the organization or predictions about individual employees or groups of employees. According to some embodiments, data collected from employee monitoring or employee characteristics may be supplied via a plurality of disparate data sources 132, 134, 136, and 140.

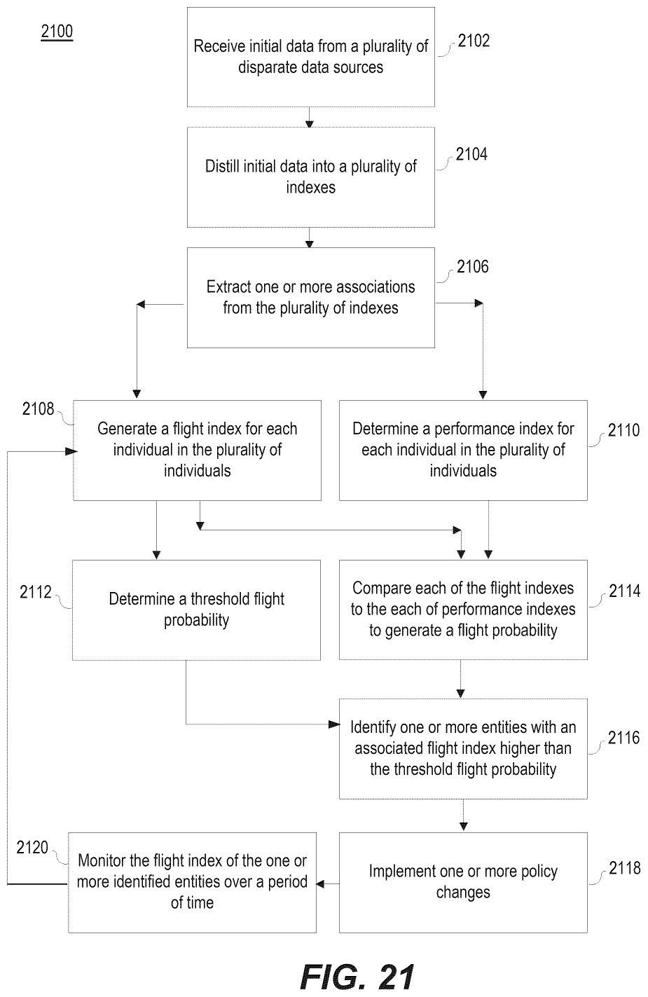

For example, data source 132 may represent the relationship 154 that a plurality of entities 142 has with their coworkers. For example, this data may be acquired by monitoring employee correspondences within an organization, as described below with respect to FIGS. 21-23.

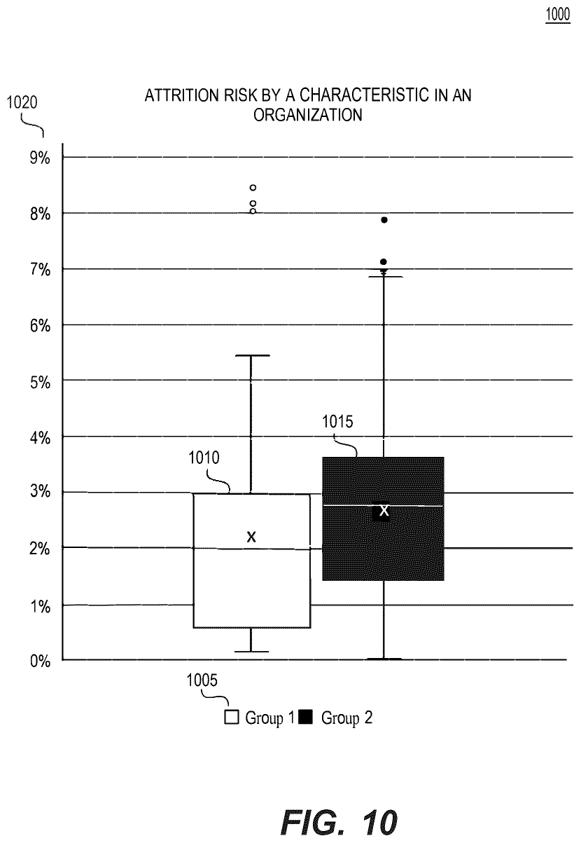

For example, data source 134 may include data collected from employee monitoring of a plurality of entities 146. Data source 134 may include input parameters associated with employee composition of the organization, for example, as discussed with respect to FIG. 10. In some embodiments, a graphical user interface 156 may be provided for display on a user device. In some embodiments, graphical user interface 156 may be an employee's personal computer and their use thereon.

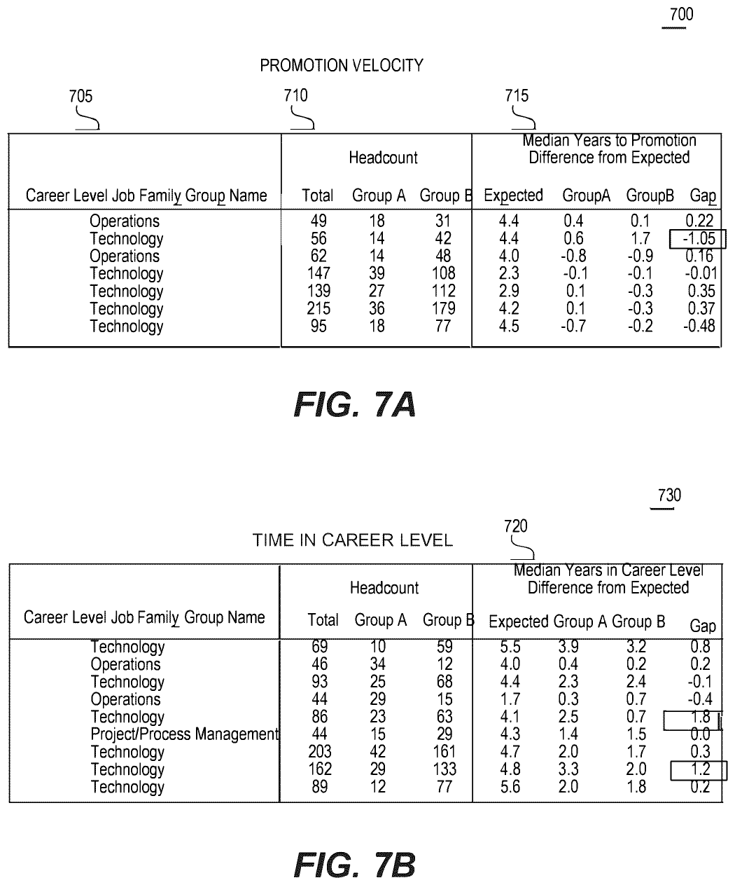

For example, data source 136 may include data collected from employee monitoring of a plurality of entities 148. Data source 136 may include characteristics 156 of a plurality of entities 148, for example as described with respect to FIG. 7. Characteristics 156 may include, for example, information associated with at least one of tenure, years in the job role, age, commute distance, performance, and payroll. Tenure may refer to the duration of time an individual has spent working in a company. Years in the job role may refer to the duration of time an individual has spent working in a specific job role, whether that is their current job role or past job role. Age may refer to the age, in years, of an individual. Commute distance may refer to the distance an individual must travel to get to work, or their office, in miles. Performance may refer to qualitative and quantitative assessments of their work performance. Payroll information may refer to an individual's salary, equity, and incentive (or bonus).

For example, data source 140 may represent characteristics 160 of a plurality of entities 152 have with their team or with the organization. For example, this data may be acquired by team monitoring or market monitoring, as described below with respect to FIG. 21. According to some embodiments, team monitoring may include employee turnover within a team, team composition, or team dynamics and inter-team connections. Market monitoring may include market data regarding job performances outside of the organization or within the organization, the need for employees in the market, the volatility of the market, or market turnover. The plurality of disparate data sources may include information associated with employee peer-to-peer recognition, manager-to-employee recognition, an employee's outstanding equity in the organization, changes in management above the employee, and organizational risk factors.

According to some embodiments, one or more identified employees 142-a, 146-a, 148-a, and 152-a may be identified from their respective groups based on one or more associations extracted from the plurality of disparate data sources, for example, as described below with respect to FIGS. 21-23.

FIG. 1D illustrates a system utilizing the data to identify individuals or entities who may fall into specified categories, according to embodiments of the present disclosure. According to some embodiments, organization 100 may utilize data collected from a plurality of disparate data sources to predictively monitor and identify employees. The predictions may forecast how certain employees or employees sharing certain characteristics will perform in the organization.

According to some embodiments, database 130 may comprise a plurality of databases. Database 130 may pass the data collected from the plurality of disparate data sources 132, 134, 136, and 140, as described above with respect to FIG. 1C and below with respect to FIG. 7, to system 180 for processing. System 180 may extract one or more associations from the plurality of disparate data sources 132, 134, 136, and 140. The one or more associations may be based on probabilistic distributions based on a relationship some or all of the data received from the plurality of disparate data sources 132, 134, 136, and 140. The system 180 may comprise a machine learning algorithm that creates a prediction based on data received from the plurality of disparate data sources 132, 134, 136, and 140. The system 180 is described in reference to the figures that follow.

System 180 may identify one or more identified employees 142-a, 146-a, 148-a, and 152-a as separate from the rest of the employees 182 at the organization. The rest of the employees 182 may be predicted to be happy and performing within their capabilities.

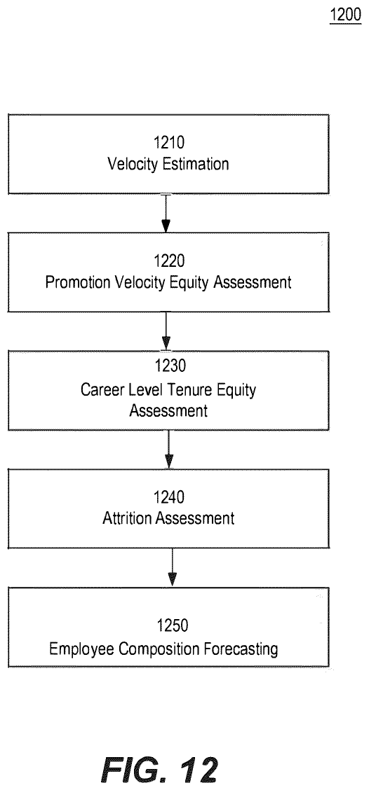

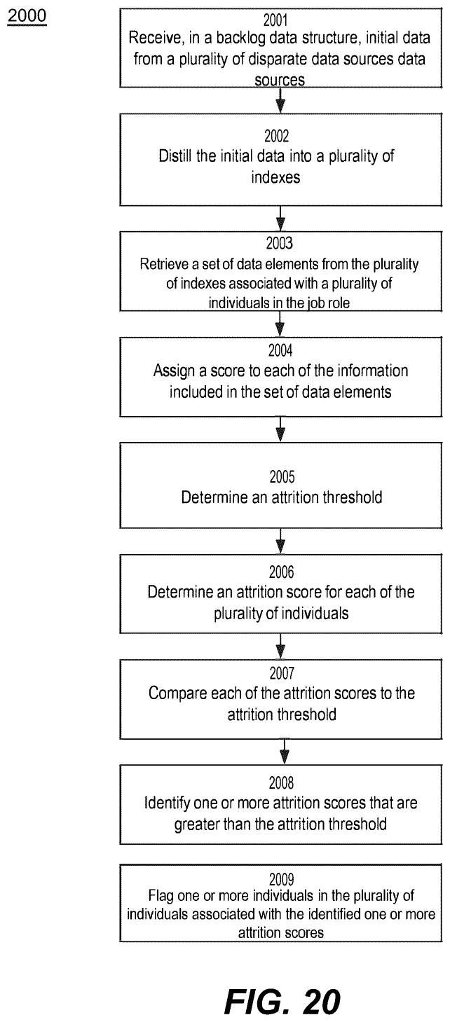

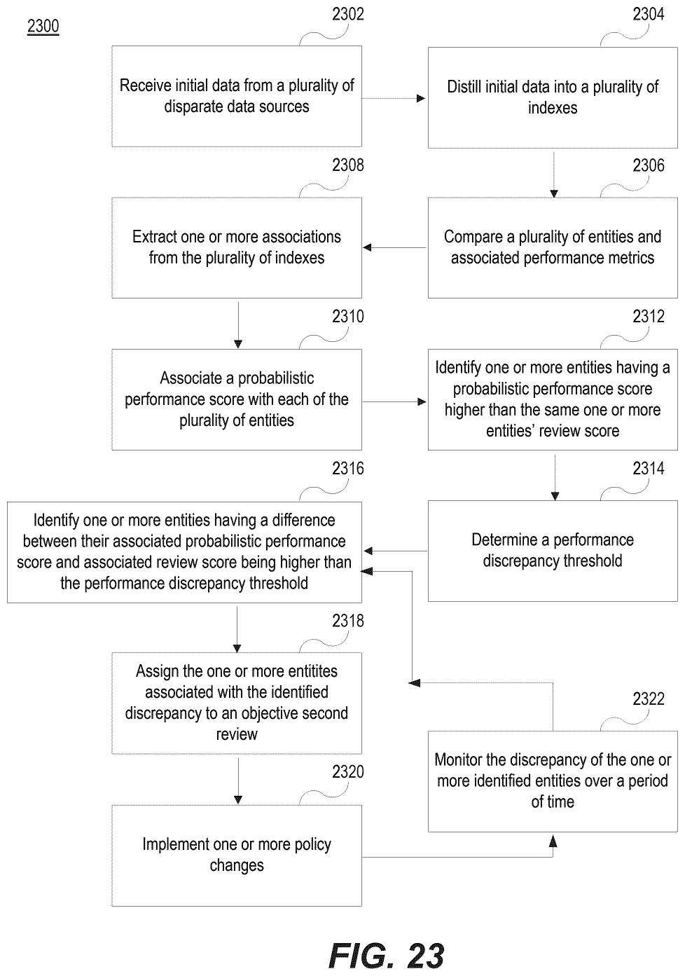

The one or more identified employees 142-a may be selected, for example, based their predicted likelihood of staying within their current role or advancing to another role based on their demographic information. This identification may be based on the extracted associations and probabilistic distributions, for example as described with respect to FIG. 12. The one or more identified employees 148-a may be selected, for example, based on their high performance and likelihood of leaving the organization. This identification may be based on the extracted associations and probabilistic distributions, for example as described with respect to FIG. 20. The one or more identified employees 152-a may be selected, for example, based on their predicted performance as a manager. This identification may be based on the extracted associations and probabilistic distributions, for example as described with respect to FIG. 21. The one or more identified employees 146-a may be selected, for example, based on their likelihood of having a review from a manager that does not match their true performance. This identification may be based on the extracted associations and probabilistic distributions, for example as described with respect to FIG. 23.

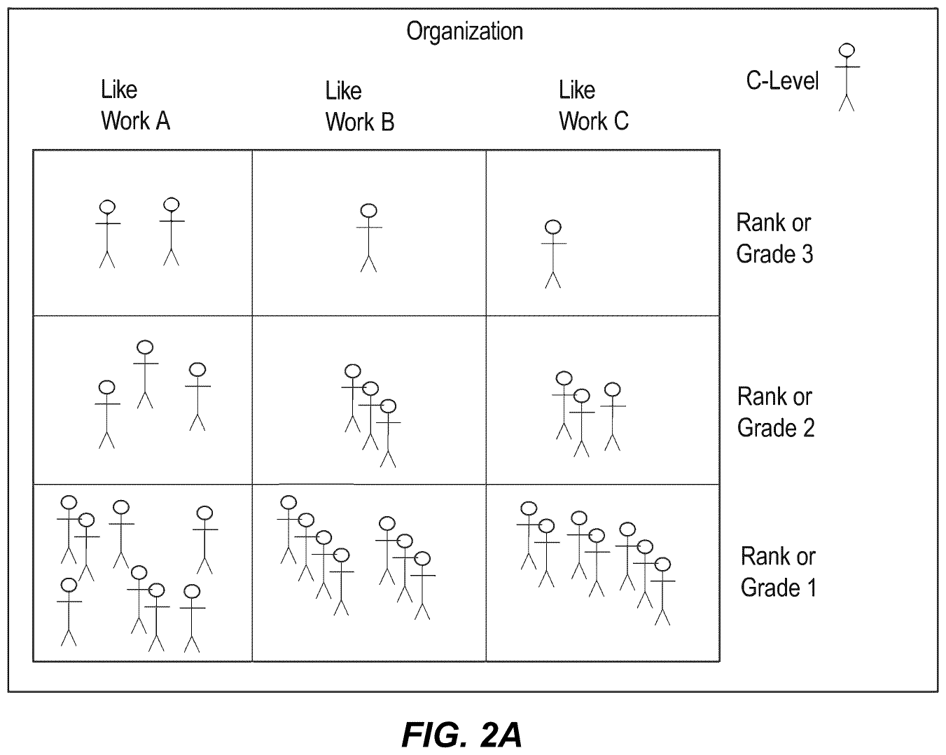

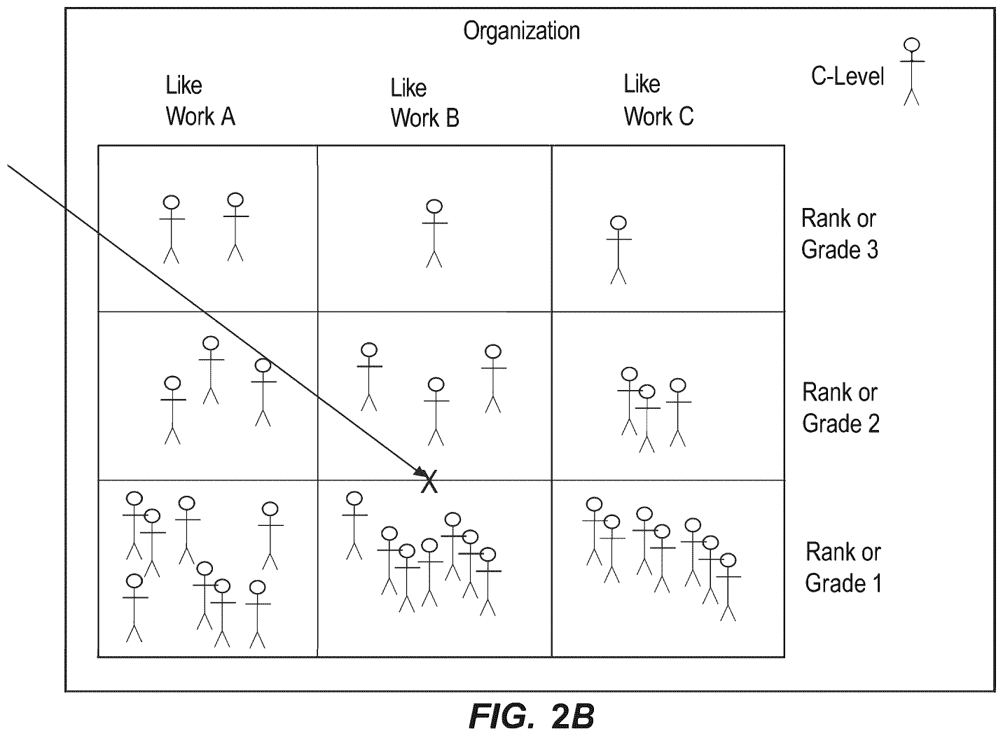

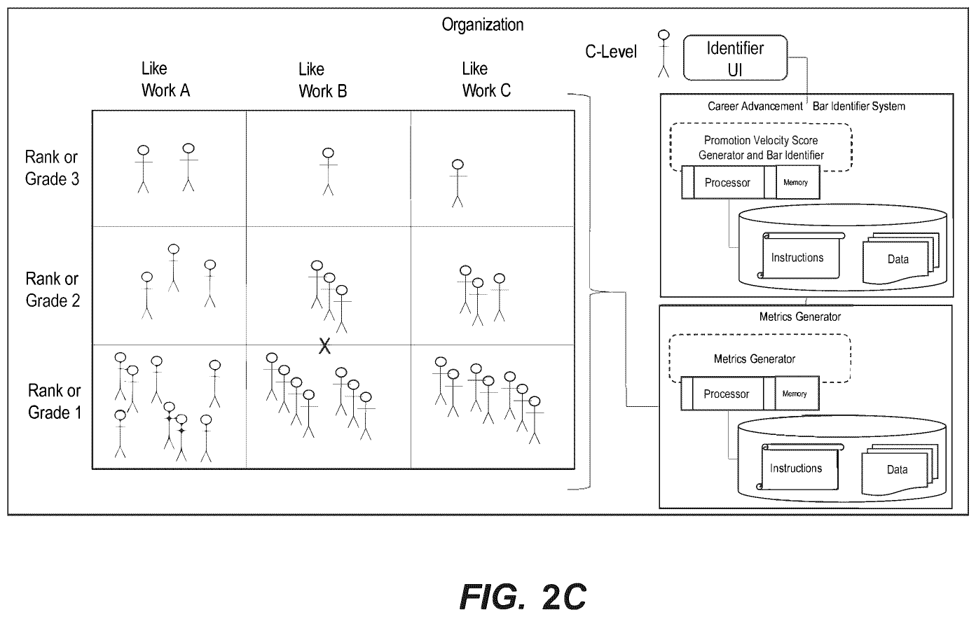

FIG. 2A presents a hypothetical scenario illustrating the concept of like-work, which is people working similar jobs all assigned a similar pay grade across the organization regardless of which sector of the organization they are working for. Employees in Grade 1 of Like-work A, B, and C are demonstrative of employees working in similar positions with similar pay across the organization. As some employees across the organization in Like-work A, B, and C advance to Grade 2 and 3 within their respective Like-work, they face imbalanced opportunities for career advancement.

FIG. 2A represents unobservable organizational structural obstacles to career

advancement. For example, a manager for Like-work A, B, or C at Level 1 may not require all his employees to complete development plans in a particular organization. This may lead only some employees in Like-work A, B, or C to develop a career development plan. This may lead to more promotions for these employees, whereas if the managers for all Like-work had ensured their employees completed the development plan, this imbalance might not have occurred.

FIG. 2C Illustrates a technological solution to identifying these impediments to career advancement. This technological solution also validates corrective actions taken after the fact. FIG. 2C illustrates a system that reads data and generates metrics to facilitate the promotion velocity score and generating representation forecasts by identifying obstacles or bars to career advancements for higher levels career placements.

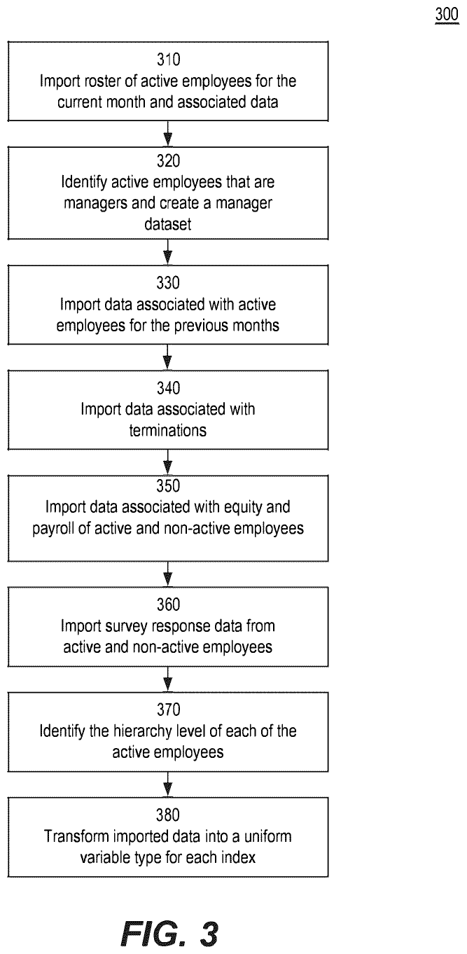

FIG. 3 presents a flowchart illustrating an exemplary method 300 for transformation of data including company or organizational information into indexes, according to embodiments of the present disclosure. The exemplary method for transformation of data into indexes may be stored as instructions in a non-transitory computer readable medium. The instructions may be executable by at least one processor for executing the transformation of data into indexes.

In step 310, the method 300 may include importing a roster of active employees for the current month and data associated with the active employees from at least one data source. An active employee may include a person currently employed by a company or organization and may be actively working and receiving compensation for their work. The at least one data source may refer to company databases, websites, user input, company files, configuration management records and any other input source for data. The associated data may include, but is not limited to, the employee identification number (ID), job code, gender, age, demographic group, years in the job, position, career rank, current salary, previous salary, most recent annual review rating, previous annual review rating, incentive, equity, supervisor identification number (ID), date hired, location of office (zip code), location of home (zip code), and commute distance. A set of associated data may be imported for each active employee. Importing data for an active employee may refer to accessing or retrieving data from a storage device (e.g., the data source) into a system or application. The imported data for each active employee may then be used for analysis, reporting, or other purposes.

In step 320, the method 300 may include identifying active employees that are managers and a manager dataset may be created. A manager may be identified by data fields in the imported data that may indicate that the job role of the active employee may be associated with a manager position. The manager dataset may include, but is not limited to, information such as age, years in the job, years with the company, gender, and review rating.

In step 330, method 300 may include importing data associated with active employees for the previous months. This data may include information about the last job role each active employee held including, but is not limited to, previous job codes, previous career level, and previous supervisor identification number (ID). If the supervisor (or manager) or career level for an active employee changed between data associated with previous months and current data, categorical variables associated with a change in manager or change in career level may be changed. A categorical variable, as may be present in data from the at least one data source, may refer to a type of data that represents a set of categories or groups. In step 330, the categorical variables in the data may relate to information associated with the last job role of the active employee. The categorical variables may be binary, meaning the variables can store, or be assigned, a value of 0 or 1. It is to be appreciated that importing data in step 330 may be similar to importing data in step 310 (e.g., data may be imported from at least one data source as previously described).

In step 340, method 300 may include importing data associated with terminations of previously active employees. Termination of an employee may refer to the process of ending the employment of the employee with a company or organization. The data may include, but is not limited to, the type of termination, termination date, and termination description.

In step 350, method 300 may include importing data associated with equity and the payroll of active and non-active employees. Payroll data may include, but is not limited to, the salary, incentive (e.g., bonus), equity, and/or full or part-time status of an employee. Payroll data may be further used to compute pay equity. Equity for the employee may refer to stock, stock options or grants that the employee may be awarded by a company. An incentive or bonus for the employee may refer to a reward or additional compensation given to the employee for achieving certain goals or to reward good job performance.

In step 360, method 300 may include importing survey response data from active and non-active employees. The survey response data may include, but is not limited to, employee ratings or reviews of their perceived career growth, perceived manager interest in their career development, perceived recognition within the company, perceived respect within the company, and trust in their team or organization. The survey response data may be used to generate a net promoter score, where the net promoter score quantifies the engagement of the employee within the organization. In step 370, method 300 may include identifying the hierarchy level of each of the active employees. Hierarchy level in the organization may refer to the level of authority or seniority that the employee holds within the organizational structure of the company and in step 370, the level of each active employee may be identified.

In step 380, the imported data may be transformed into a uniform variable type for each index. The transforming may include assigning a binary value, 0 or 1, to a representative categorical variable for imported data designed to go into an index. For example, a change in an employee's manager within the past 3 months may be transformed into a categorical variable “manager_change_3mo” where the statement that the variable represents is true and thus the variable may be set to 1 (“manager_change_3mo=1”). The same process may be performed for the data associated with an index that represents recent career development changes of the employee. The index then may be generated by combining the categorical variables. In one embodiment, this combining may be performed by calculating the mean, or average, of the categorical variables. It is to be appreciated that any type of statistical calculation or numerical calculation may be used to perform the combining of categorical values. An index may be a composite statistic, or a measure of changes in a representative group of individual data points. An index may be a categorical, numerical, and/or ordinal value. Categorical indexes may be used to group data into specific categories or groups. Numerical indexes may be used to represent numerical values, such as by age or salary level. Ordinal indexes may be used to rank data in a specific order, such as a rating system for employee performance. Different types of indexes may be used to categorize or group data based on specific criteria or characteristics, numerical information and/or statistical data type.

Distilling data may refer to the process of analyzing and summarizing imported data to extract the relevant information. An example of distilling the data may be transforming or translating data obtained from survey responses. The imported data may be numeric in nature, such as a number between 1 and 10. The data may be transformed into a categorical variable by identifying responses that are above a certain number as a 1. For example, an employee can rate their perceived recognition within the organization as a number between 0 and 10. If the employee rates their perceived recognition as 9 or 10, the associated categorical variable may be set to true, or 1 (“enps_recog_promoter=1”). If the employee rates their perceived recognition as 7 or 8, another categorical variable may instead be set to true, or 1 (“enps_recog_passive=1”) If the employee rates their perceived recognition as 0, 1, 2, 3, 4, 5, or 6, a third categorical variable may instead be set to true, or 1 (“enps_recog_detractor=1”). For example, a certain numerical level may be established as a threshold, such as between 7 and 8. If the employee has rated their perceived recognition as a 9 (which is greater than 8), the categorical variable may be set to true, or 1. If the employee has rated their perceived recognition as a 6 (which is less than 7), the categorical value may be set to false, or 0. This transformation process may be performed for other survey responses and other imported data not listed. An index associated with the survey responses may be generated by combining the associated categorical variables. In one embodiment, this combining may be performed by calculating a mean, median or other type of statistical or numerical value, of the categorical variables.

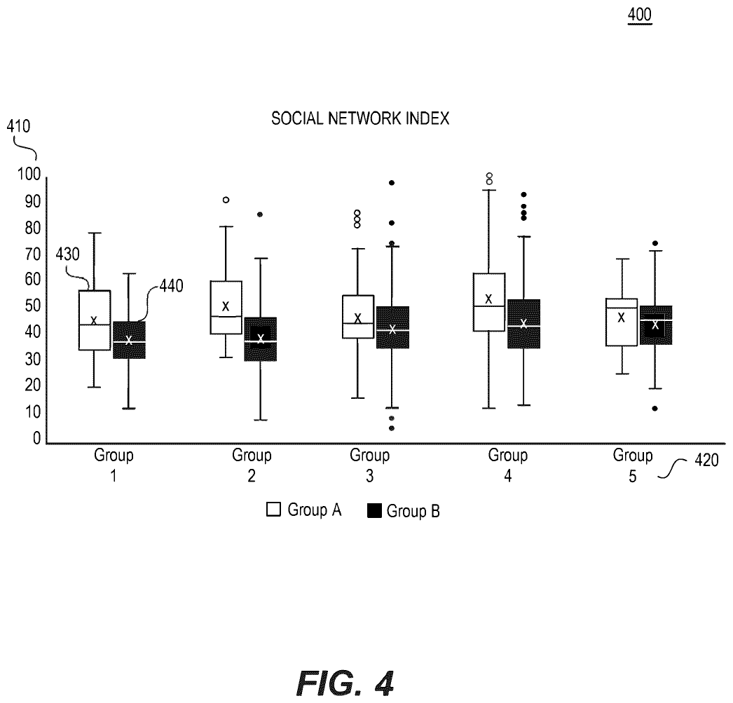

FIG. 4 illustrates an example output of indexing in the form of a social network index 400, according to embodiments of the present disclosure. “Social network index” may generally refer to a measure of the level of social interaction and connectivity within a particular network or community. A social network index may be used to analyze the strength and breadth of relationships between individuals or groups, as well as to identify key influencers and trends within the network. Consistent with some disclosed embodiments, the social network index may be calculated by transforming imported data, such as the sender and recipients of internal correspondence (e.g., email, instant messaging). For example, in response to the sending of an email, one or more processors may assign a categorical variable of one, and the one or more processors may adjust a social network index value based on an aggregate of the categorical value associated with sending the email. As shown in FIG. 4, the social network index 410 may be a numeric index with a value between 0 and 100. The social network index number index 410 may correspond to an individual or a group 420. A lower value may indicate less social engagement and a higher value may indicate more social engagement. In FIG. 4, for each group 420 displayed, for example, “Group 1,” sub-groups may be presented that represent different groups within a demographic trait, such as Group A 430 and Group B 440, as shown. In other embodiments, the sub-groups may be based on ethnicity, such as African American, Asian, White, Hispanic, and Other. It is to be appreciated that groups may include, for example, family, friends, employees, neighbors, demographics, ethnicities, and/or any other grouping of people that may interact socially. Further, the social network index may be represented by a value calculated using mean, average, or any other statistical calculation.

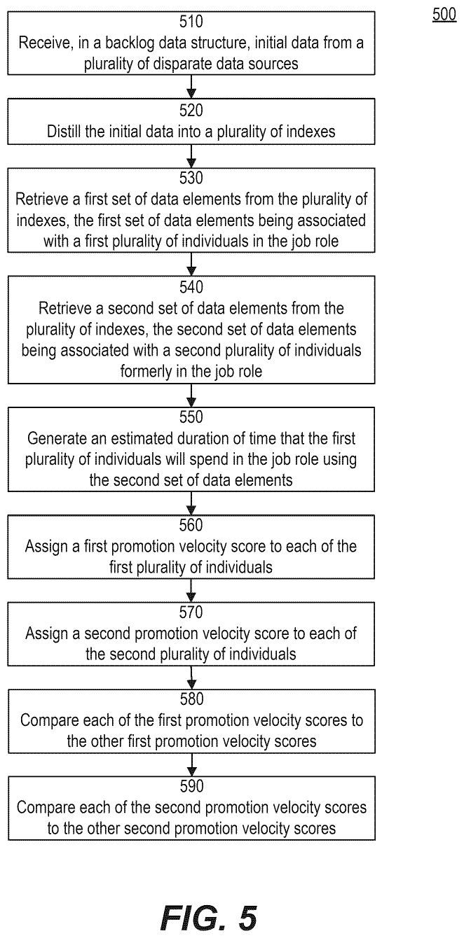

FIG. 5 presents a flowchart illustrating an exemplary method 500 of determining promotion velocity, according to embodiments of the present disclosure. Promotion velocity may refer to the rate at which employees are promoted to higher positions within a company or organization. By way of a non-limiting example, promotion velocity may be measured by the average time taken for an employee to be promoted or the percentage of employees who are promoted within a certain time frame. A promotion velocity algorithm may be stored as instructions in a non-transitory computer readable medium. The non-transitory computer readable medium storing instructions, that, when executed by at least one processor, cause the at least one processor to perform operations for executing the promotion velocity algorithm to perform operations for identifying and predicting inequality outcomes in a job role.

As shown in FIG. 5, method 500 may include a step 510 of receiving data from a plurality of disparate data sources, the data including a plurality of variables. As described previously, data sources may refer to company databases, websites, user input, company files, configuration management records and any other input source for data. Disparate data sources may refer to differences in characteristics of each of the data sources and the type of data that may be retrieved from each data source. For example, the data received from a plurality of disparate data sources may include correspondence data, survey response data, payroll data, and talent data. Correspondence data may include, for example, the sender and/or recipients of electronic mail (hereafter referred to as e-mail or email) correspondence. Correspondence data may further include the date and time that an email is sent and/or received. In some embodiments, correspondence data may also include the sender and/or recipients of instant messages. Correspondence data may be received from an email or messaging server. Survey response data may include, for example, employee responses to internal surveys. The responses may include rating on a scale what the employee thinks of their career growth opportunities, manager's interest in their career development, recognition within the organization or company, respect within the organization or company, and/or relationship with their organization. Survey response data may be received from user input or may be received as input from a company file where survey data may be maintained.

Elements of the received data may correspond to data types and variables associated with promotion velocity regarding the plurality of entities in a position. An element of received data may refer to a piece of information within a larger set of the received data. The element of the received data may be a variable or an object that holds a specific value or information. Data types may refer to the different categories of data that can be stored and used in a software application, for example, integer data, string data, Boolean data and binary data. A variable may generally refer to a value or data type that may change within the context of a specific element of data that the variable represents. Each variable of the plurality of variables may be associated with a data type and an entity of a total plurality of entities. For example, payroll data may include information (e.g., elements of payroll data) about the employee number, salary, tax information and other employment data related to an employee. Each element of payroll data for the employee may correspond to a variable (e.g., each element of payroll data may be a variable because it may take on different values for different employees). An entity may refer to a specific object or concept that may be represented in the data. For example, in a database of employee information, each employee may be considered an entity. Further, each object containing employee information may have a plurality of variables associated with the employee information. An entity in a position may refer to an employee in a particular job role. Promotion velocity regarding the plurality of entities in a position may refer to the rate at which employees are promoted to higher positions from the particular job role.

Method 500 may include a step 520 of distilling the data into a plurality of indexes to convert the data into the plurality of indexes to be usable by a single data structure. The data may be distilled by assigning a binary value to each variable of the plurality of variables, wherein each variable is a categorical value, a numerical value, or an ordinal value. An index may be generated using the binary value of each variable for each data type and each entity of the total plurality of entities. Each index may be stored in a database. The distillation may include importing the data in its original type. The original type of the data may be different for the different information included in the data. In some disclosed embodiments, the type of data may be talent data. Talent data may include information associated with employees in a job role such as the career rank, hire date, location, duration of time in the job role, and demographic traits. The talent data may include different types such as categorical (or nominal), ordinal, or numeric. The talent data may include information of each type. For example, the demographic traits may be categorical, the career rank may be ordinal, and the duration of time in the job role may be numeric. The distillation may include reading the data and translating, or transforming, the information in the data into one uniform type. Uniform type may refer to a data type where all elements within the data set are the same data type. Continuing with the previous example, the demographic traits and career rank of an employee may be translated, or transformed, into a numeric type. As a result, the demographic traits, career rank, and duration of time in the job role may become one uniform type, numerical. Then, an index, or composite indicator, may be assigned to the talent data of the employee based on a mathematical transformation, such as a mean, average or any type of statistical calculation or numerical calculation that may be used to perform the mathematical transformation of the translated or transformed demographic traits, career rank, and duration of time in the job role.

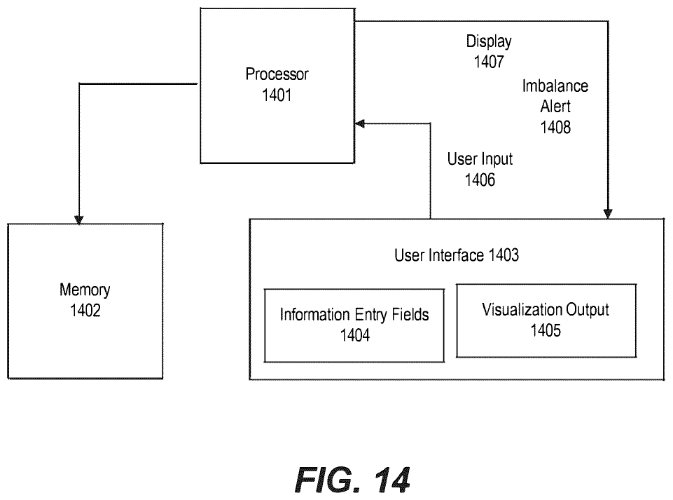

Step 520 may improve computer performance speed because processor 1401, as shown in FIG. 14, need not access multiple data structures. Instead, the plurality of indexes created by step 520 may be usable by a single data structure. Therefore, processor 1401 may only need to access a single data structure instead of multiple data structures. Accessing data structures may involve accessing buffers in memory 1402. Computer performance speed may relate to the amount of buffers processor 1401 needs to access in memory 1402. Therefore, step 520 may improve computer performance speed because step 520 may allow for processor 1401 to access fewer buffers in memory 1402.

Furthermore, step 520 may improve computer performance by conserving computer memory in memory 1402, shown in FIG. 14. Step 520 may allow for the data to be saved in memory 1402 in the form of indexes, rather than in the data's initial form. Storing the data in the form of indexes may require less memory, and therefore, storing data in the form of indexes may conserve memory. Accordingly, step 520 may improve computer performance speed.

As shown in FIG. 5, method 500 may include a step 530 of retrieving a first set of data elements from the plurality of indexes. Retrieving, as in retrieving data, may refer to accessing or reading stored information from a memory (e.g., database, server, RAM and any other storage medium). The first set of data elements may be associated with a first plurality of entities of the total plurality of entities. In some embodiments, the first plurality of entities of the total plurality of entities may include individuals in a job role. The first set of data elements may include, but is not limited to, information associated with an actual duration of time in the job role and one or more demographic traits. The demographic traits may refer to characteristics of a population including age, gender, ethnicity, education level, income, occupation, cultural background or other identifying features of a group of people. The first plurality of individuals may be current employees who are still in the job role.

As shown in FIG. 5, method 500 may further include a step 540 of retrieving a second set of data elements from the plurality of indexes. The second set of data elements may be associated with a second plurality of entities of the total plurality of entities. In some embodiments, the second plurality of entities of the total plurality of entities may include individuals in a job role. The second set of data elements may further include information associated with an actual duration of time in the job role and one or more traits. The second plurality of individuals may be current employees who were promoted and are no longer in the job role.

Method 500 may include step 550 of generating a predicted duration of time that the first plurality of entities may remain in the first position, as shown in FIG. 5. The first position may include, but is not limited to, the job role. The predicted duration of time may be generated by using the second set of data elements associated with the second plurality of entities. The second plurality of entities may include the second plurality of individuals. For example, the average duration of time that the second plurality of individuals, who were formerly in the job role, spent in the job role may be used as the estimated duration of time that the first plurality of the individuals who are currently in the job role will spend in said role. In another embodiment, the estimated duration of time may be calculated by a weighted average that includes the actual duration of time that the second plurality of individuals were in the job role and one or more other factors, such as whether each of the second plurality of individuals were terminated, promoted, or had some other change to their position within the company.

As shown in FIG. 5, method 500 may include step 560, where a first velocity index may be assigned to each of the first plurality of entities to obtain a plurality of first velocity indexes. A velocity index may refer to a metric used to measure the speed and efficiency of career advancement for an employee within a company. A metric may refer to a quantitative measure used to assess or evaluate a particular aspect of a system or process. Consistent with some disclosed embodiments, velocity indexes may be used in determining promotion velocity for a plurality of entities. The first velocity index may be directly proportional to a measure of closeness between the predicted duration and the actual duration of time in the position in the first set of data elements. For example, the first velocity index of step 560 may be directly proportional to the difference between the estimated duration and actual duration of time spent in a particular position in the first set of data elements. In another example, the velocity index may be a calculated residual of, or difference between, the predicted, or estimated, duration of time in a position (e.g., job role) and the actual duration of time in the position. In some embodiments, the operations may be performed for a plurality of positions. As shown in FIG. 5, method 500 may include a step 570, where a second velocity index may be assigned to each of the second plurality of entities to obtain a second plurality of second velocity indexes. The second velocity index may be directly proportional to a measure of closeness between the predicted duration and actual duration of time in the position in the second set of data elements. The second velocity index may be calculated in a manner similar to that described above for the first velocity index.

As shown in FIG. 5, method 500 may include a step 580 of comparing each of the first velocity indexes to other first velocity indexes from among the plurality of first velocity indexes. The comparing of first velocity indexes may include identifying differences between each of the first velocity indexes and identifying information associated with a data category of each of the first plurality of entities. For example, a difference between a first velocity index and the average of the first velocity index may be calculated. This difference may be used to identify first velocity indexes that are greater than a specified, predetermined amount. The corresponding data categories (e.g., demographic traits or characteristics) can be identified. In one example, the data category may be associated with one or more traits or characteristics of each individual of a group of individuals. Identifying the information associated with the traits or characteristics may involve comparing promotion velocities of the individuals in the group and determining if there may be differences in promotion velocities of the individuals based on different traits or characteristics.

In some embodiments, the first velocity indexes may be separated into two groups where one group includes the first velocity indexes associated with one category of traits or characteristics and a second group includes the first velocity indexes associated with a second category of traits or characteristics. For example, the traits or characteristics may be enjoyment of a personal activity or sport. A first group of velocity indexes may be created based on enjoyment of the personal activity or sport. A second group of velocity indexes may be created based on a lack of enjoyment of the personal activity or sport. The median of the first group of velocity indexes and the median of the second group of velocity indexes may be calculated. The medians may be compared to assess a gap, or difference, between the two. The gap may identify where promotion velocities differ based on demographic traits. This may identify where a lack of opportunity, or broken rung, may be occurring. In another embodiment, the trait can be regional location. In another embodiment, the trait can be age. In another embodiment, the trait can be time spent in the office. It should be understood that the trait may be any characteristic associated with one or more entities.

As shown in FIG. 5, method 500 may include a step 590 of comparing each of the second velocity indexes to other second velocity indexes from among the plurality of second velocity indexes. The comparing of second velocity indexes may be performed in a manner similar to that described above with respect to comparing of the first velocity indexes. Based on the first plurality of velocity indexes and the second plurality of velocity indexes, a velocity model may be generated. A velocity model for promotion velocity may include a mathematical model that predicts the rate at which employees may be promoted within a company. The velocity model may be used to identify high-potential employees and to develop strategies for career advancement of those employees.

The operations may further include creating a distribution of the velocity indexes. Creating a distribution refers to organizing and displaying data in a way that shows the frequency or probability of different values. In some disclosed embodiments, the distribution may be created based on a plurality of velocity indexes. For example, the distribution of the velocity indexes may be created for the job role. The distribution may include the first and second velocity indexes. The operations may further include generating a score associated with an expectation that one or more entities in the first plurality of entities will move from their current position (e.g., current job role) to another position (e.g., a new job role code). The score may be generated based on a plurality of contributing factors associated with a determination of whether one or more entities may be likely to move to another position, and based on the contributing factors, calculate an estimate of likelihood of the entity moving to another position. In some embodiments, the score may be calculated as a number, probability, rating or similar metric representing likelihood of an entity changing position. Using the score, a quantity of a projected first plurality of entities in the position over a duration of time may be generated. The velocity indexes may be used to estimate a probability that one or more individuals in the first plurality of individuals will be promoted. For example, a positive velocity index may be indicative of a higher probability that an individual will be promoted. A velocity index that is higher than another velocity index (for example, 1.7 and 1.0) may be indicative of a higher probability that an individual will be promoted. The velocity index may measure the rate at which employees are promoted within a company or organization and thus a higher velocity index refers to a higher rate or probability of promotion within the company or organization. Thus, in some embodiments, a value of the velocity index may be directly proportionate to a likelihood of a promotion.

The operations may further include generating a graphical user interface containing information entry fields for receiving user input regarding input parameters and datasets regarding the entity characteristics. Receiving user input may refer to accepting and processing user entry through an interface (e.g., a graphical user interface), on a computer, mobile device or other device that may accept user data entry. The user input may include text, numbers, selections, and other types of data. The user input may be provided using one or more of a keyboard, a mouse, buttons, levers, switches, checkboxes, pulldown menus, touchscreens and any other data entry method via a graphical user interface. The graphical user interface may allow user input regarding input parameters associated with promotion velocity. In some embodiments, the graphical user interface may be provided for display on a user device. The input parameters and datasets received in the entry fields of the graphical user interface may define the data to be used to calculate the velocity indexes. For example, entry fields may allow user input to be received that identifies the first set of data elements and the second set of data elements to use to calculate the velocity indexes. In one example, a user input may identify a specific demographic trait, such as described in a previous example, the first set of data elements may be associated with a first demographic trait (e.g., female) and the second set of data elements may be associated with a second demographic trait (e.g., non-female). The operations may further include receiving, from the graphical user interface via the user device, one or more input parameters and generating a second projected first plurality of entities in the position over the duration of time based on the one or more input parameters. In some disclosed embodiments, entry at the graphical user interface may allow user input of input parameters to cause a prediction of the entities in a position over a period of time. Returning to the example of input parameters relating to demographic traits, the first set of data elements that may be selected by input parameters entered by the user may be associated with the first demographic trait (e.g., education level, for example college educated individuals). An additional input parameter that may be selected by input parameters entered by the user may initiate an analysis for projecting the number of entities with the first demographic trait that may be in the position after the period of time (e.g., prediction of promotion velocity for college educated individuals in the first set of data elements). Thus, the input parameters may be used to set up an analysis of promotion velocity based on the specific individual or groups that the user may intend to analyze or compare, by allowing the user to select the first set of data elements and the second set of data elements to perform the analysis.

By way of a non-limiting example, an expected employee composition of a projected first plurality of entities in the job role over a duration of time may be generated. The expected employee composition may refer to the level of variation in terms of demographics, skills, experiences, and perspectives among employees that an organization aims to achieve. The expected employee composition may be determined by generating a velocity model for the plurality of entities in the job role and using the generated velocity model to predict the future level of variation of the plurality of entities in the job role over a duration in time. The expected employee composition may be based on several factors such as enjoyment of a personal activity or sport, time spent in the office, regional location, gender, race, ethnicity, age, education, and cultural background. The probability that one or more entities in the first plurality of entities will be promoted may be used to predict the plurality of entities in different job roles in the future (e.g., the level of variation of employees) and thus allow for a determination of the expected employee composition. The expected employee composition may be used to determine an expected level of variation of the job role in a specified duration of time and may allow for an evaluation of whether the expected composition may achieve organization goals for employee composition in the job role or not. For example, if the organization goals for employee composition are met, as shown by the prediction of expected employee composition, the expected employee composition of a plurality of entities in a job role may be evaluated under different conditions by removing the data of the entities who have a velocity index over a certain threshold. The characteristic data of the remaining entities may be used to generate expected employee composition that meets the goals of the organization.

In some embodiments, the operation of predicting how many individuals will be promoted and no longer in the job role may be implemented using a machine learning model. The data retrieved in step 540, which is associated with a second plurality of individuals formerly in the job role, may be used as training data to train a machine learning model. A machine learning model may be trained by providing it with a large dataset of labeled examples from received data from company data sources. The received data may have been distilled into a plurality of indexes. It is to be appreciated that the machine learning model may be trained on the received data, distilled data or any other imported data. The training of the machine learning model may be based on using an algorithm to adjust the parameters of the model until the model can accurately predict the most appropriate output for new, unseen received data (e.g., imported data from the data sources). For example, such a machine learning model may be used to predict how many individuals who are currently in the job role will be promoted. The machine learning model may be trained on a dataset of examples associated with job role data where, consistent with some disclosed embodiments, the most appropriate output may be a velocity index or a velocity model based on input data related to job role.

FIG. 14 illustrates an example of a system diagram configured to perform functions of the disclosed embodiments. In some disclosed embodiments, the operations may include a user interface 1403 (e.g., graphical user interface) including information entry fields 1404 for receiving user input regarding characteristic input parameters. Characteristic input parameters may refer to input received in the entry fields of the user interface that may define the data to be used to calculate the expected employee composition. For example, characteristic input parameters may include parameters that may be entered related to target expected characteristic goals such as the desired mix by gender, ethnicity, cultural, education level and any other characteristic that an organization may determine may be representative of a desired composition of employees. The operations may include receiving from the user interface 1403 one or more characteristic input parameters. The operations may further include generating a second expected composition of the first plurality of entities in the job role over a duration of time based on the one or more characteristic input parameters. Generating the expected employee composition may include calculating the level of variation (e.g., statistical variation) between the first and second plurality of entities over a period of time. The one or more characteristic input parameters may change the expected composition of hiring, change the expected composition of promotion, or change the expected composition of retention. Changing the expected composition of hiring may include changing the distribution of a certain demographic trait in entities to be added to the first plurality of entities in the second expected composition. Changing the expected composition of promotion may include changing the distribution of a certain demographic trait in individuals to be removed from the first plurality of entities in the second expected composition. Changing the expected composition of retention may include changing the distribution of a certain demographic trait in the first plurality of entities. The operations may further be performed for a plurality of job roles. It is to be appreciated that changing the characteristic input parameters may change the variation in the expected composition and as such, the user may adjust characteristic input parameters to generate different predicted results to determine approaches to achieve company objectives, for example in hiring, promotion and retention.

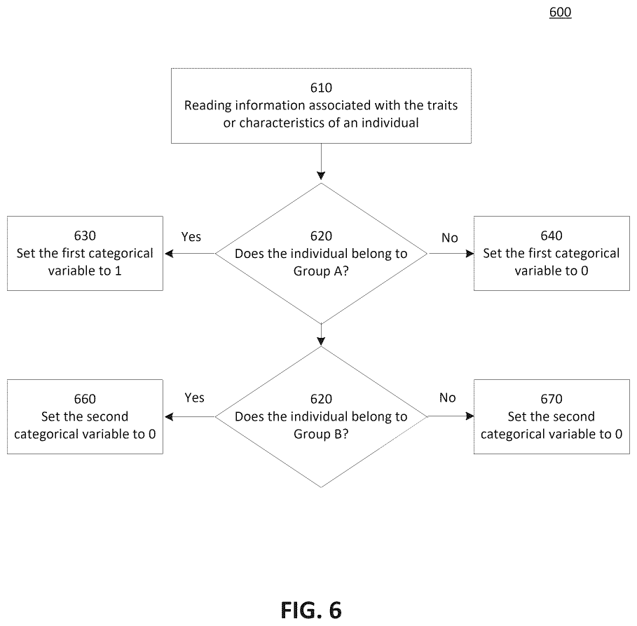

FIG. 6 presents a flowchart illustrating an exemplary method 600 of identifying differences in demographic traits, according to embodiments of the present disclosure. Method 600, as shown in FIG. 6, may be a form of distilling or transforming initial qualitative data into categorical values in a categorical variable that may further be distilled in an index to be usable by a single data structure. Information from a set of data associated with the demographic traits of an individual, or employee, may be imported from data sources as previously described and exemplified in this disclosure.

Method 600 may include step 610 of reading information associated with the demographic traits of an individual. In one exemplary embodiment, the information may be the gender, ethnicity, level of education, place of birth, age, or any other characteristic of the individual. As shown in FIG. 6, method 600 may include a step 620 where the qualitative value of the input information is evaluated. The qualitative values of information associated with ethnicity may be African American, Asian, Hispanic, White, or the like. The qualitative values of information associated with level of education may be high school, college, graduate, or the like. For example, method 600 may include an output 630 where a first categorical variable may be set to 1 if, while reading the information, it is determined that an individual belongs to Group A. Further, method 600 may include an output 640, where a first categorical variable may be set to 0 if it is determined that an individual does not belong to Group A. Furthermore, method 600 may include a step 650, where, if while reading the information it is determined that an individual is a member of Group B, then method 600 may include an output 660 where a second categorical variable may be set to 1. If it is determined that an individual is not a member of Group B, then method 600 may include an output 670 where the second categorical variable may be set to 0.

FIG. 7A illustrates an example of calculated promotion velocity medians of different groups in promotion velocity table 700 using the promotion velocity algorithms described, according to embodiments of the present disclosure. In the promotion velocity table 700, promotion velocity mean may refer to the statistical measure that represents the middle value of years to promotion. As shown in FIG. 7A, columns and headings may be presented in an output. The columns may include Career 705 including “Career Level,” “Job Family,” and “Group Name,” Headcount 710 including “Headcount totals,” and Median Years to Promotion 715 including “Median Years to Promotion,” and “Difference from Expected.” Career Level may describe the hierarchy of a job family. Job Family may describe the general classification of the type of job role. Examples of job families may be Operations or Technology, as shown in FIG.

7A. Group Name may describe the group or team.

Headcount 710 may describe the distribution of individuals having a certain trait. Headcount may include columns delineating the total number of individuals included in a certain category or row, the number of individuals who belong to a specific group of people in a certain category or row, and the number of individuals who do not belong to the specific group of people in a certain category or row.

Median Years to Promotion 715 may describe a general group of columns that show the median years to promotion of individuals in a job role. The Difference from Expected may describe the difference calculated between the median years to promotion of a group of individuals and the expected median years to promotion of an individual in a certain row. The Difference from Expected may include three columns describing the difference calculated between the median years to promotion of different demographic groups and a gap between the calculated difference from expected of the demographic groups. As shown in FIG. 7A, the demographic groups may those belonging to Group A and those belonging to Group B.

In FIG. 7A, the expected median years to promotion may be determined by taking the average of the actual duration of time individuals who were previously in the job role (and promoted) spent in the job role. As shown in FIG. 7A, the promotion velocity may be positive and/or negative values. Furthermore, a gap between different demographic groups may be calculated. This gap may identify organizations or job families where the equity between different demographic groups may be lacking. For example, as shown in the second row Technology job family, a gap of −1.05 between Group A and Group B may be indicative of a systemic bias that affects the professional development and advancement of employees who identify with a demographic group within the job family. In other embodiments, the output may show differences and gaps between other demographic groups. In other embodiments, the promotion velocity may show mean years to promotion.

FIG. 7B illustrates an example of a calculated time in a career level 630 of different demographic groups, according to embodiments of the present disclosure. As shown in FIG. 7B, columns and headings presented in the output may include columns and headings previously discussed with respect to FIG. 7A, but with respect to Median Years in Career Level 720. The Median Years in Career Level 720 may describe the difference between the median actual duration of time a plurality of individuals spends in a career level compared to the expected (e.g., average or median of the estimated years to promotion). The output is similar to that of the promotion velocity shown in FIG. 7A. The expected time in a career level can be calculated in a manner similar to that of step 550 shown in FIG. 5. The median years that individuals in a career level that identify with a certain demographic group may be calculated. In other embodiments, the mean may be calculated and shown in the output. A gap between median years, or duration of time spent in a career level, of different demographic groups may be determined by calculating the difference between the duration of time each individual has spent in a career level and the expected duration of time an individual will spend in the career level. For example, as shown in the fifth row of FIG. 7B, the gap between median years in a career level for Group A and Group B individuals in a Technology job family is calculated to be 1.8. This may show that individuals who are Group Ain the Technology job family represented in the fifth row spend on average 1.8 more years in the role compared to individuals who are in Group B. The gap may be indicative of systemic bias in a job family, organization, and/or company as the professional development and advancement of individuals who belong to a minority group may be negatively impacted by this systemic bias. The organization may then identify the characteristic associated with each of Group A and Group B and therefore identify the shared characteristic that is causing delayed merit promotion for that group of employees.

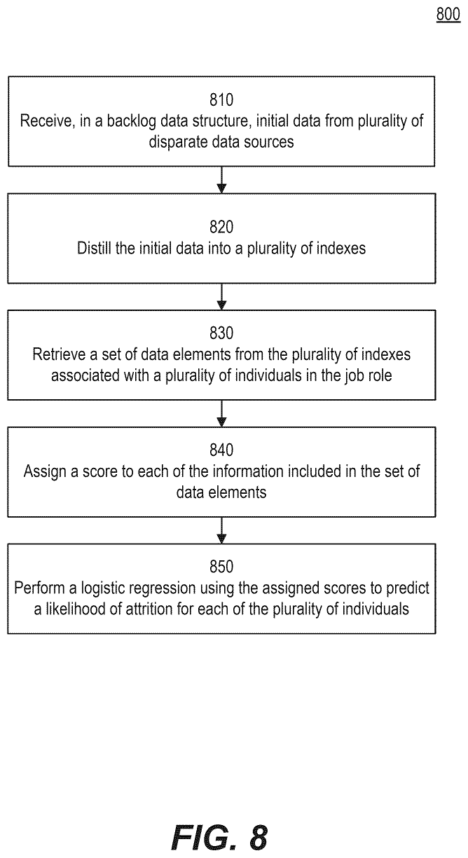

FIG. 8 presents a flowchart illustrating an exemplary method for determining a likelihood of attrition, according to embodiments of the present disclosure. The attrition model algorithm may be stored as instructions in a non-transitory computer readable medium. The non-transitory computer readable medium may include at least one processor that executes the attrition model algorithm to predict attrition of employees in a job role.

As shown in FIG. 8, method 800 may include step 810 of receiving data from a plurality of disparate data sources, the data including a plurality of variables associated with attrition. Attrition may refer to the rate at which employees leave or are terminated from their positions. Attrition may be measured as a percentage of the number of employees who leave the company within a certain time period versus the total number of employees. For example, the data received from the plurality of disparate data sources may include correspondence data, survey response data, payroll data, and talent data. The data may include a plurality of variables, each variable of the plurality of variables may be associated with a data type and an entity of a plurality of entities in a position. Elements of the received data may correspond to data types and variables associated with attrition regarding the plurality of entities in a position.

Method 800 may further comprise step 820 of distilling the data into a plurality of indexes to convert the data into the plurality of indexes to be usable by a single data structure, shown in FIG. 8. The data may be distilled by assigning a binary value to each variable of the plurality of variables, wherein each variable is a categorical value, a numerical value, or an ordinal value, by generating, using the binary value of each variable, an index for each data type and each entity of the total plurality of entities and by storing each index in a database. Details explaining the distilling and converting of the data are described and exemplified in step 520 of method 500. Step 820 may improve computer performance speed because processor 1401, as shown in FIG. 14, may only need to access the indexes in a single data structure. The details of how step 820 may improve computer performance speed are described and exemplified elsewhere in this disclosure. Furthermore, step 820 may improve computer performance by conserving computer memory in memory 1402, shown in FIG. 14. Details of how step 820 conserves computer memory are described and exemplified elsewhere in this disclosure.

As shown in FIG. 8, method 800 may include a step 830 of retrieving a set of data elements from the plurality of indexes. The set of data elements may be associated with the plurality of entities, for example the plurality of individuals in the job role. The set of data elements may include information associated with at least one of tenure, years in the job role, age, commute distance, performance, and payroll. Tenure may refer to the duration of time an individual has spent working in a company. Years in the job role may refer to the duration of time an individual has spent working in a specific job role, whether that is their current job role or past job role. Age may refer to the age, in years, of an individual. Commute distance may refer to the distance an individual must travel to get to work, or their office, in miles. Performance may refer to qualitative and quantitative assessments of their work performance. Payroll information may refer to an individual's salary, equity, and incentive (or bonus).

As shown in FIG. 8, method 800 may include step 840 of assigning an attrition index to each of the information or to each of the entities included in the set of data elements. Attrition index may refer to metrics used to measure the rate at which employees leave or are terminated from their positions within the company. Examples of metrics that may be used to determine an attrition index may include the number of employees who have left the company, the reasons for their departure and the length of time they were employed. The attrition index may be determined from metrics that may be binary in nature, such as a 0 or 1 (e.g., false or true). For example, the information associated with performance may be transformed from a qualitative value into a categorical value. Performance values may include Exceeds Expectations, Meets All Expectations, Meets Some Expectations, and Too New to Rate. If the qualitative performance value is Exceeds Expectations or Meets All Expectations, an associated performance categorical variable may be assigned the value 1. If the qualitative performance value is Meets Some Expectations or Too New to Rate, the performance categorical variable may be assigned the value 0.

As shown in FIG. 8, method 800 may include step 850 of predicting, using the attrition index, attrition for each entity of the plurality of entities. Attrition may be a binary event. For example, the likelihood of attrition may be a binary event or outcome, where 1 indicates attrition is likely. Thus, based on the values of the metrics associated with the attrition index, an algorithm may be used to predict attrition for a plurality of entities. In one example, the entities may be individuals in a particular job role and the prediction may be the level of attrition (e.g., the percentage of employees that may leave the job role versus the total number of employees in the job role).

In some embodiments, step 850 may be used to implement a machine learning model. The data retrieved in step 830 that is associated with a plurality of entities (e.g., individuals in the job role) may be used as training data to train a machine learning model. Such a machine learning model may be used to perform step 850, where a prediction, using the attrition index, may be used to predict the likelihood of attrition. The machine learning model may be trained on a training dataset, including with attrition data and metrics data associated with the attrition index together with an associated rate of attrition. The trained machine learning model may be configured to predict the rate of attrition when provided with inputs including attrition data and metrics data associated with the attrition index.

The operations may further include creating a distribution of attrition for the position (e.g., job role). The distribution may use the attrition of each entity of a plurality of entities. The distribution may include the attrition indexes. The operations may further include generating, using the distribution, a quantity of a projected plurality of entities in the position over a duration of time. The operations may further include generating a visualization of the distribution.

The operations may further include generating a graphical user interface containing information entry fields for receiving user input regarding input parameters. The input parameters received in the entry fields of the graphical user interface may define the data to be used to calculate attrition index and/or attrition. The graphical user interface may allow user input regarding input parameters associated with attrition. In some embodiments, the graphical user interface may be provided for display on a user device. The operations may further include receiving, from the graphical user interface via the user device, one or more input parameters and generating a second projected first plurality of entities in the position over the duration of time based on the one or more input parameters. In some disclosed embodiments, at least one processor may receive, via input by the user, one or more input parameters such as gender, age, location of employment, job role and other characteristics to determine the set of data elements to analyze. The disclosed system may use these input parameters to recalculate a prediction of the attrition rate for each entity over a period of time. Thus, by providing different input parameters, the user of the disclosed system may be able to evaluate the effect of the input parameters on the predicted attrition rate.

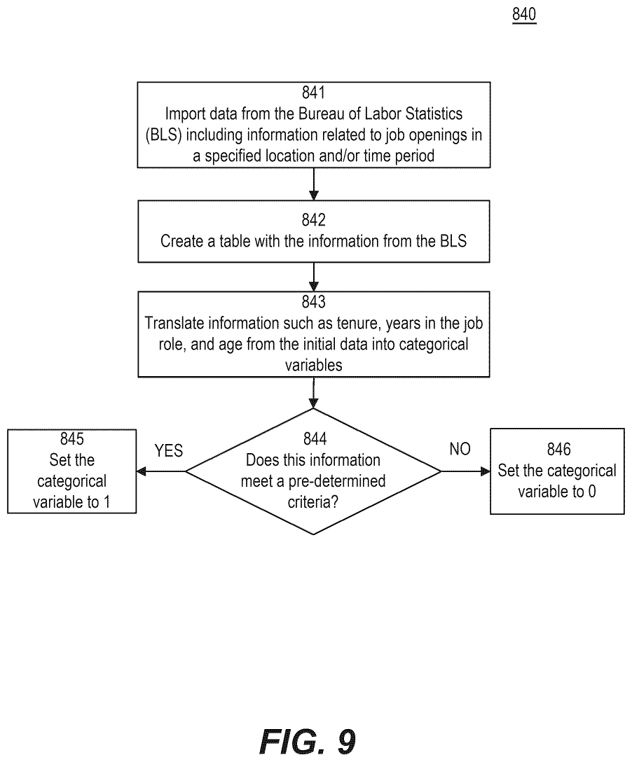

FIG. 9 presents a flowchart describing method 840, which may include an exemplary process, for example, the assignment step 840 of FIG. 8. Method 840 may include step 841 of importing data from the Bureau of Labor Statistics (BLS). The data may include information related to job openings in a specified location and/or period of time. Method 840 may also include step 842, where a table is created with the BLS data. The table may include information on labor economics and statistics, such as data on employment, wages, productivity, and occupational safety and health, that may be used in determining the likelihood of attrition. The BLS data may be used to determine the likelihood of attrition due to factors outside of the organization (e.g., higher salary and other benefits at other organizations as indicated by the BLS data). The determination of the likelihood of attrition may include predicting the likelihood of individuals leaving the organization due to outside incentives at other organizations, such as higher pay, for example.

In some embodiments, the BLS data may be used as training data to implement step 850 using a machine learning model. The BLS data may be used as training data in a similar way to the data received in step 830 that is associated with a plurality of individuals in the job role. The BLS training data may be used to train a machine learning model. Such a machine learning model may be used to perform step 850, where a prediction of the likelihood of attrition may be predicted using the attrition index. The machine learning model may be trained on a training dataset, including with BLS data and metrics data associated with the attrition index together with an associated rate of attrition. The trained machine learning model may be configured to predict the rate of attrition when provided with inputs including BLS data and metrics data associated with the attrition index.

As previously explained in the context of information associated with performance, method 840 may include step 843, which may be a process including translating information from the imported BLS data and assigning a binary value to categorical variables that represents each of the information or to each of the entities in the set of data elements may be performed. For example, method 800 may contain a step 844 where multiple categorical variables may be assigned information. With respect to age, six categorical variables may be created where they are defined by age groups 1-24, 25-27, 28-34, 35-44, 45-64, and 64+. As an example, if information indicates that an individual is 36 years old, then method 840 may include an output 845 where the categorical variable associated with the age group 35-44 will be assigned the value, or set to, 1. Alternatively, if the pre-determined criteria are not met, method 840 may contain an output 846 where the categorical variable is set to zero.

FIG. 10 illustrates an output of the attrition model algorithm 1000 displaying the attrition risk of individuals in an organization by different demographic groups, according to embodiments of the present disclosure. The demographic groups 1005 shown in FIG. 10 are Group 1 1010 and Group 1 1015. An organization may be a job family or team. As shown in FIG. 10, an attrition risk 1020 may be presented as a percentage based on the combination of each likelihood of attrition for each individual. This transformation from likelihood of attrition of each individual to an attrition risk 1020 of a group may be performed by calculating the number of likelihood of attrition events being positive or true (or assigned a 1) compared to the total number of individuals in a specific group. For example, in FIG. 10 the mean attrition risk 1020 calculated for individuals of the Group 1 1010 demographic group may be calculated to be 2%, meaning that 2 in 100 individuals in the Group 1 1010 demographic group of the organization have a positive likelihood of attrition. Thus, attrition risk 1020 may provide a predictor of expected attrition over a period of time for a group of individuals. Adjusting input parameters related to attrition may allow a user to evaluate changes within the organization to reduce attrition risk.

In some embodiments, the attrition risk 1020 presented in FIG. 10 may present the attrition risk 1020 for other demographic groups or groups of employees sharing a specific characteristic.

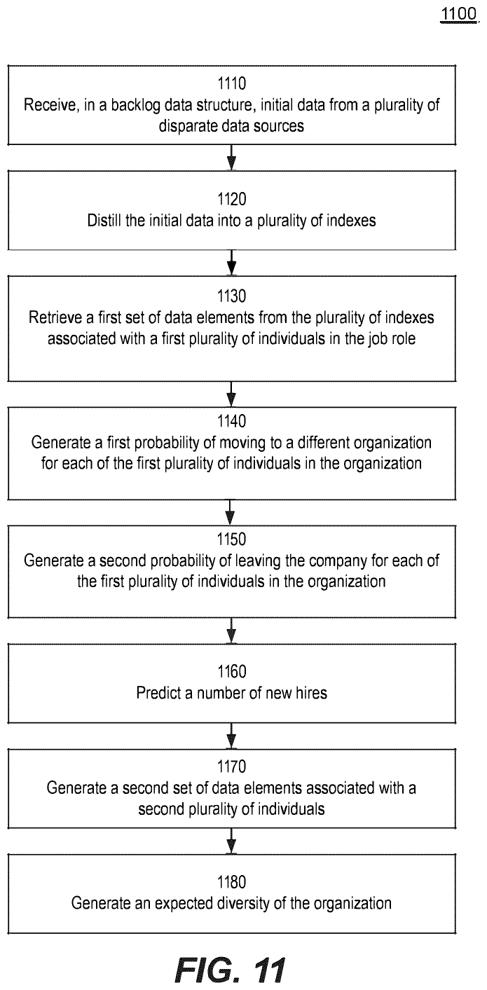

FIG. 11 presents a flowchart describing the employee composition forecasting algorithm, according to embodiments of the present disclosure. The employee composition forecasting algorithm may be stored as instructions in a non-transitory computer readable medium. The non-transitory computer readable medium may include at least one processor that executes the employee composition forecasting algorithm to predict the employee composition of an organization within a company over a duration of time.

As shown in FIG. 11, method 1100 may include step 1110 of receiving data from a plurality of disparate data sources, the data including a plurality of variables associated with employee composition forecasting. Employee composition forecasting may refer to predicting the future employee composition of the workforce (e.g., plurality of entities) based on current trends and demographics. Variables associated with employee composition forecasting may include demographic trends, hiring practices, retention rates, and employee engagement levels. For example, the data received from the plurality of disparate data sources may include observed employee movement over a period of time. Employee movement may refer to changes in job roles (e.g., from one job to another job) for employees in the company. Observed employee movement may refer to a record kept related to changes in job roles for employees over a period of time. The data may further include correspondence data, survey response data, payroll data, and talent data. Each variable of the plurality of variables may be associated with a data type and an entity of a plurality of entities in a first position. Elements of the received data may correspond to data types and variables associated with employee composition forecasting regarding the plurality of entities in the position.

Method 1100 may include step 1120 of distilling the data into a plurality of indexes to convert the data into the plurality of indexes to be usable by a single data structure. The plurality of indexes may include velocity index, attrition and network analytics index. The data may be distilled by assigning a binary value to each variable of the plurality of variables, wherein each variable is a categorical value, a numerical value, or an ordinal value, by generating, using the binary value of each variable, an index for each data type and each entity of the total plurality of entities and by storing each index in a database. Details explaining the distilling and converting of the data are described and exemplified elsewhere in this disclosure. Step 1120 may improve computer performance speed because processor 1401, as shown in FIG. 14, may only need to access the indexes in a single data structure. The details of how step 1120 improves computer performance speed are described and exemplified elsewhere in this disclosure. Furthermore, step 1120 may improve computer performance by conserving computer memory in memory 1402, shown in FIG. 14. Details of how step 1120 conserves computer memory are described and exemplified elsewhere in this disclosure.

As shown in FIG. 11, method 1100 may include step 1130 of retrieving a first set of data elements from the plurality of indexes associated with a first plurality of entities. The first probability may be calculated by a first mathematical transformation that includes the velocity index, attrition and network analytics index. For example, the first plurality of entities may be individuals who are currently in the organization. The organization may be a job family or a team. The information included in the first set of data elements may include a velocity index, social networking index, pay equity score, engagement score, attrition, network analytic index and one or more demographic traits. Processes of obtaining a velocity index and likelihood of attrition are discussed in the above sections of this disclosure.

A social networking index may quantify the engagement and social network of an individual. The engagement of an individual may describe how engaged they are with other individuals in their company. The engagement score may quantify the engagement of an individual. The social network of an individual may describe the amount of people they know and interact with within and/or outside of their company. The social network index may be measured through internal email traffic and resulting patterns. An employee's internal Social Network Analytic Index (SNA), or social network index, may include the following: dividing the number of sent emails by the number of received emails; the unique inbound and outbound contacts; the importance of node/employee connecting the graph (these employees may be called brokers); and the number of important nodes/employees. Cross-line-of-business (cross-LOB) connections may also be considered for job roles that are revenue generating, or cross-selling. The contents, or body, of emails are not read or analyzed.

A pay equity score may quantify the salary, equity, and incentive that an individual receives in relation to their work performance. The pay equity score may show whether individuals in similar job roles who have similar work performance quality are paid similarly. Pay equity scores may be calculated by analyzing factors such as job title, experience, education, and performance to determine any disparities in pay between employees of different genders, races, or other demographic groups.

As shown in FIG. 11, method 1100 may include a step 1140 where a first probability of moving to a different position for each of the plurality of entities in the organization may be generated. The first probability may be calculated by a first mathematical transformation that includes the velocity index, social networking index, pay equity score, likelihood of attrition, and engagement score. The first mathematical transformation may be a weighted average of the values mentioned previously. In some embodiments, the first mathematical transformation may be a weighted sum of the values. In other embodiments, the first mathematical transformation may be an average, a sum or statistical calculation or numerical calculation may be used to perform the operation.

As shown in FIG. 11, method 1100 may include a step 1150 where a second probability of moving to a second different position for each of the plurality of entities in the organization may be generated. The second probability may be calculated by a second mathematical transformation that may include the velocity index, social networking index, pay equity score, attrition, network analytic index and engagement score. The second mathematical transformation may be a weighted average of the values mentioned previously. In some embodiments, the second mathematical transformation may be a weighted sum of the values. In other embodiments, the second mathematical transformation may be an average or a sum (not weighted). Thus, the first probability relates to the probability of moving to a first different position and the second probability relates to the probability of moving to a second different position.

As shown in FIG. 11, method 1100 may include step 1160 of predicting the number of second entities that may include a number of entities expected to move to the first position. For example, a number of new hires may be predicted. The number of new hires may be a number of individuals expected to join the organization. The prediction may be performed by importing data associated with previous hiring practices. For example, the average number of new hires over a past three-month duration may be used as the predicted number of new hires. The duration is not limited to three months.

As shown in FIG. 11, method 1100 may include step 1170 where a second set of data elements associated with a second plurality of entities may be generated. The second set of data elements may include data based on the prediction of the number of entities that may be expected to move to the first position. The second plurality of entities may be a hypothetical group of individuals who are predicted to be part of an organization. The generating may include applying a third mathematical transformation to the first probability of step 1140, the second probability of step 1150, and the prediction of the number of second entities step 1160 (e.g., number of new hires). For example, the first probability of step 1140 and second probability of step 1150 may predict a number of individuals that will leave the organization. The number of new hires of step 1160 may provide a number of individuals that will enter or join the organization. Thus, the second plurality of individuals may be predicted by subtracting the number of individuals provided by the first and second probabilities of steps 1140 and 1150 and by adding the number of individuals provided by the number of new hires of step 1160. In some embodiments, the information, such as demographic traits, associated with each individual predicted by the first and second probabilities may be identified. Information, such as demographic traits, may be assigned to each individual in the number of individuals provided by the number of new hires.

Method 1100 also may include step 1180, where an expected composition of entities in the first position may be generated. Composition of entities in a position may include the mix of the workforce in the position based on factors such as age, gender, education level, experience, and job role. The generating may include identifying at least one data category of each of the second plurality of entities. Based on the prediction of the number of entities that may be expected to move to the first position, in step 1180, the expected composition may be calculated. The expected composition may include the composition of the entities in the first position. For example, an expected employee composition of the organization may be generated based on the prediction of the number of new hires and associated demographic traits. In some embodiments, the operations may further comprise displaying a visualization of the expected composition.

The operations may further include generating a graphical user interface containing information entry fields for receiving user input regarding input parameters. The input parameters associated with velocity index, attrition and network analytics index received in the entry fields of the graphical user interface may define the data to be used to calculate expected composition. The graphical user interface may allow user input regarding input parameters associated with employee composition of the organization. In some embodiments, the graphical user interface may be provided for display on a user device. The operations may further include receiving, from the graphical user interface via the user device, one or more input parameters. The one or more input parameters may change one or more of the first probability, the second probability, and the prediction of the number of second entities. The operations may further include generating a second expected composition of entities in the first position based on the one or more input parameters. In some embodiments, the operations may further comprise displaying a second visualization of the second expected composition. In some disclosed embodiments, entry at the graphical user interface may allow user input of input parameters to cause a prediction of expected composition in a first position over a period of time.

FIG. 12 presents a flowchart illustrating another exemplary method for forecasting employee composition, according to embodiments of the present disclosure.

As shown in FIG. 12, method 1200 may contain a step 1210, and the velocity estimation step 1210 may include a linear mixed effects regression to estimate the expected time an employee (e.g., an employee currently in a job or career level, a new employee entering a job or career level) may spend in a given career level. Velocity estimation may include analyzing the career trajectory of an employee and predicting the future career growth of an employee based on their current performance and potential. The velocity estimation step 1210 may control for key factors impeding career movement such as job type, manager, job family, and the like. In some embodiments, controlling for key factors involves taking into account or adjusting for the effects of the factors impeding career movement that may be influencing the outcome of career movement.

As shown in FIG. 12, method 1200 may include step 1220, the promotion velocity assessment step. Promotion velocity assessment may include evaluating the rate of advancement of the employee within a company or organization. The evaluation may include assigning a score to the employee promotion potential. Step 1220 may include assigning the score to promoted employees using the velocity estimation step 1210. The expectation (or prediction) may be compared to an actual duration of time spent in a career level by an individual. A heuristic algorithm may be performed to flag differences in promotion velocity by gender, ethnicity, or any other identified characteristics. Flagging differences may involve identifying the variations in promotion velocity based on the characteristic of the individual versus a control group (e.g., a different gender or a specific ethnicity to compare with while performing the heuristic algorithm). Flagging differences may be performed by setting a categorical variable associated with a certain value to a 1 (similar to the process discussed previously).

As shown in FIG. 12, method 1200 may include step 1230, the career level tenure equity assessment step. Career level tenure equity assessment may refer to evaluating the fairness and equity of promotion policies based on the length of service and career level of an employee. The career level tenure equity assessment step 1230 may include using the velocity estimation step 1210 to estimate an expected time in a current level of an individual or a group of individuals. A heuristic algorithm may be used to examine individuals with actual durations of time in a role exceed the expected time in the current level or role. Differences by gender, ethnicity, or any other identified characteristic may be flagged.

As shown in FIG. 12, method 1200 may include the attrition assessment step 1240. As described and exemplified previously, attrition may be predicted using an attrition index and in step 1240 an attrition assessment may be performed based on the attrition and/or attrition index. In method 1200, step 1240 may include a logistic regression used to predict a likelihood of attrition within a time window. In some embodiments, the time window may be three (3) months. A distribution of attrition risk by gender and ethnicity, or by any other characteristics as described above, may be assessed for key job families, as shown in FIG. 10.

As shown in FIG. 12, method 1200 may include step 1250, employee composition forecasting. As described previously, employee composition forecasting may include predicting the future employee composition of the employees of a company based on current trends and demographics. In method 1200, the employee composition forecasting step 1250 may include using matrix mathematics to estimate a probability of transitioning to new roles, terminations of individuals in a job role, and/or hiring of new individuals in the job role. The transition probabilities may be applied to a current employee base, or plurality of individuals, and grouped by demographic traits. An expected employee composition may be forecasted over a time window based on the transition probabilities and/or hiring practices. In some embodiments, the time window may be five (5) years. In some embodiments, the employee composition forecasting step 1250 may allow a user input to generate scenarios of changes in the employee composition of hiring, promotion, and retention. In some embodiments, the user input may change at least one of the first probability, the second probability, or the number of new hires. The employee composition forecasting step 1250 may generate an expected or estimated employee composition over a time window. In some embodiments, the time window may be five (5) years.

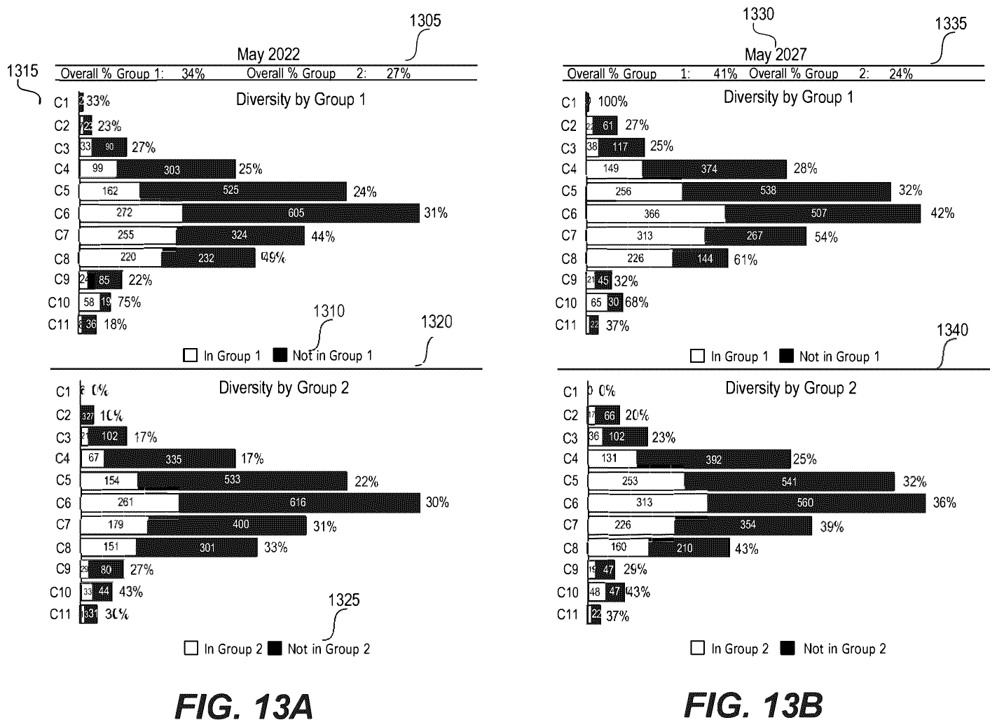

FIG. 13A illustrates an output of the employee composition forecasting algorithm showing the present composition of employees within a company, according to embodiments of the present disclosure. As shown in the top chart of FIG. 13A, the present employee composition output may display groups by Group 1 1305, such as Group 1 and Not in Group 1 1310. As shown in the bottom chart of FIG. 13A, the present employee composition output may display groups by Group 2, such as In Group 2 and Not in Group 2 1325. Each horizontal bar may be associated with a different career level 1315 (e.g., C1 is a generic term for a first career level 1315) and show the composition within that job role. In other embodiments, the output may display the present composition within a single job role instead of a company. In other embodiments, the output may display the present composition in which the career levels may instead be job roles. In some embodiments, the composition output may show terminations or termination rates, as opposed to active employees. Furthermore, in some embodiments, the employee composition output may show new hires. The output may be generated to a spreadsheet or table.

FIG. 13B illustrates an output of the employee composition forecasting algorithm showing a predicted, or expected, employee composition within a company, according to embodiments of the present disclosure. As shown in FIG. 13B, the employee composition may be predicted for five years from a previously specified date 1335 (shown by example as May 2022 in FIG. 13A and May 2027 in FIG. 13B). As shown in the top chart of FIG. 13B, the composition forecast may display groups by Group 1 1330, such as In Group 1 and Not in Group 1 1310. As shown in the bottom chart of FIG. 13B, the employee composition forecast may display groups by Group 2 1340, such as In Group 2 and Not in Group 2 1325. Each horizontal bar may be associated with a different career level 1315 and show the composition within that career level 1315. In other embodiments, the output may display the present composition where each horizontal bar is associated with a different job role. In other embodiments, the output may display the present composition within a job role. In some embodiments, the employee composition output may show terminations or termination rates, as opposed to active employees, which is what is currently displayed. The output may be generated to a spreadsheet or table.

As shown in FIG. 14, the system may include at least one processor, like processor 1401, for example. Processor 1401 may be connected to memory 1402. Processor 1401 may also be connected to user interface 1403. User interface 1303 may contain information entry fields 1404 for receiving user input. These inputs may be, for example, but are not limited to, one or more characteristic input parameters. Processor 1401 may receive user inputs 1406 from user interface 1403. User interface 1403 may also contain a visualization output 1405. Processor 1401 may communicate displays 1407 to user interface 1303 for display on visualization output 1405. Such visualizations may be, for example, but are not limited to, the output of the employee composition forecasting algorithm as shown in FIG. 13B.

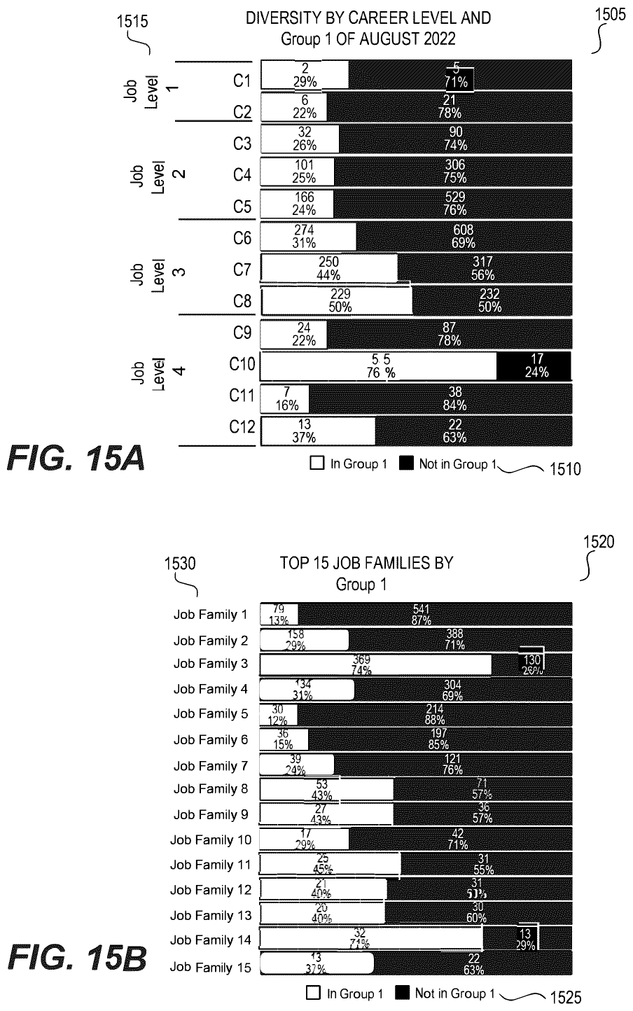

FIG. 15A illustrates an exemplary output of the employee composition forecasting algorithm showing the present employee composition of career levels within a company, according to embodiments of the present disclosure. As shown in FIG. 15A, the employee composition 1505 of each career level 1515 (denoted by the letter “C” and followed by a number) may be displayed or visualized. The career levels may be further grouped by job level, sometimes called a career suite. In some embodiments, the employee composition of job roles may be displayed and may be further grouped by career level 1515. The demographic trait shown may be gender, such as In Group 1 or Not in Group 1 1510, as shown in FIG. 15A. In other embodiments, the demographic trait shown may be ethnicity. In other embodiments, the demographic trait shown may be any identified characteristic. In some embodiments, multiple demographic traits may be displayed.

FIG. 15B illustrates another exemplary output of the employee composition forecasting algorithm showing the present employee composition of the top 15 job families in a company 1520, according to embodiments of the present disclosure. In some embodiments, any job families 1530, not just the top 15, may be shown. In other embodiments, career levels may be shown instead of job families 1530. The demographic trait shown may be gender, such as In Group 1 and Not in Group 1 1525, as shown in FIG. 15B. In other embodiments, the demographic trait shown may be ethnicity. In other embodiments, the demographic trait shown may be any identified characteristic. In some embodiments, multiple demographic traits may be displayed.

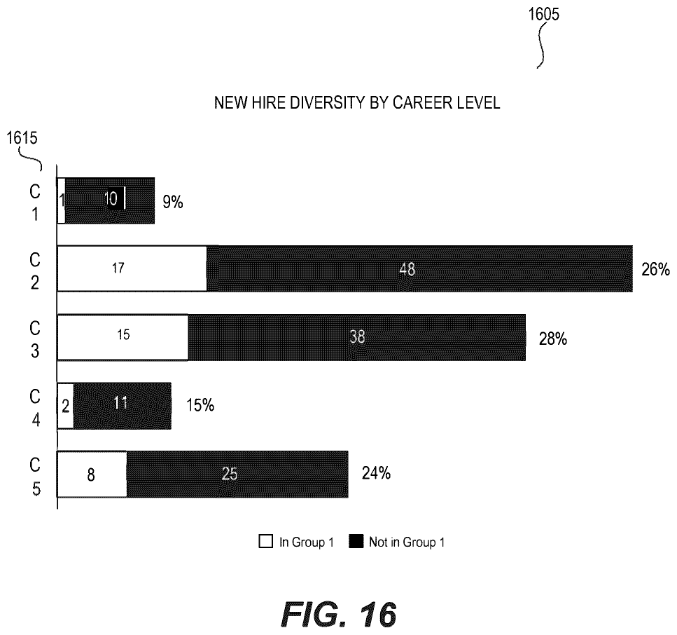

FIG. 16 illustrates an exemplary output of the employee composition forecasting algorithm showing the present composition of new hires by career level 1605, according to embodiments of the present disclosure. The output may display groupings by career level 1615 (denoted by the letter “C” and followed by a number). In other embodiments, the output may display groupings by job families. The demographic trait shown may be gender, such as In Group 1 or Not in Group 1 1610, as shown in FIG. 16. In other embodiments, the demographic trait shown may be ethnicity. In other embodiments, the demographic trait shown may be any identified characteristic. In some embodiments, multiple demographic traits may be displayed.

The number of individuals in each category may be shown on the output. For example, in FIG. 16, the output shows 1 “in Group 1” new hire and 10 “Not in Group 1” new hires in the C1 career level. A percentage may be displayed that shows the percentage of In Group 1 new hires compared to total new hires in a career level. For example, in C1, 9% of the new hires were In Group 1 (1 In Group 1, 10 Not in Group 1).

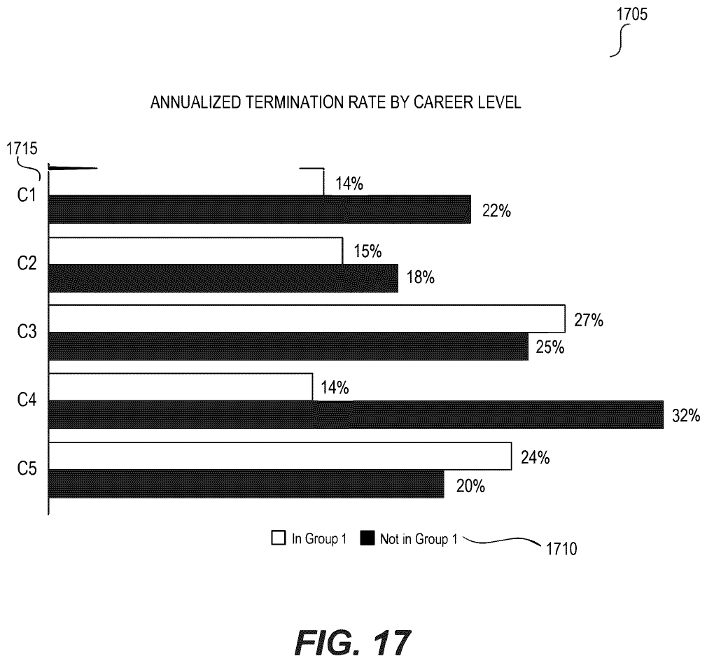

FIG. 17 illustrates an exemplary output of the employee composition forecasting algorithm showing the composition of annual terminations by career level 1705, according to embodiments of the present disclosure. In some embodiments, the composition of annual terminations may be shown by job families and/or job roles instead of career level 1715. As shown in FIG. 17, the annualized termination rate by gender, such as In Group 1 and Not in Group 1 1710 may be shown. For example, in C1 the annualized termination rate of individuals identifying as In Group 1 is 14% and the termination rate of individuals as Not in Group 1 is 22%. In some embodiments, the demographic trait shown may be ethnicity. In other embodiments, the demographic trait shown may be any identified characteristic. In other embodiments, multiple demographic traits may be displayed.

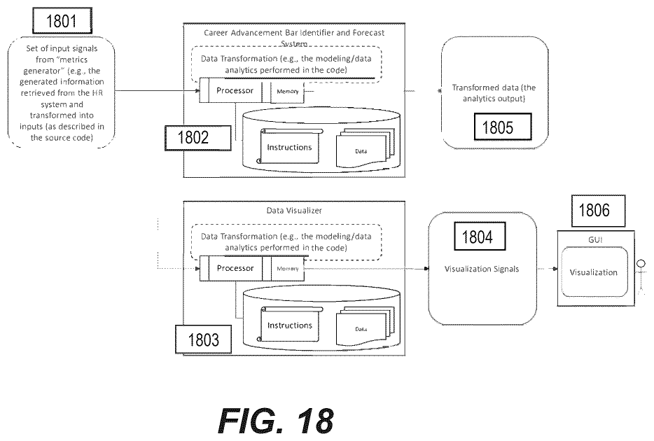

FIG. 18 illustrates the use of data visualization tools to display model results to a user using a graphical user interface 1806. Some embodiments of the present disclosure may transform the data that can be presented to a user via a user display. Input signals such as information received from the HR system and transformed into input described in the source code, 1801 may be sent to the processor 1802, where, based on the input signals, data may be pulled from the memory to undergo a data conversion or transformation. In some embodiments, the processor contains a set of instructions, embedded in the code, that may be executable by the processor to facilitate the transformation of data into a plurality of indexes. In other embodiments, the processor is responsible for analyzing, manipulating, and interpreting the input signal. In other embodiments, the processor is a software program. In other embodiments, the processor is a hardware device. In other embodiments, the processor is a digital signal processor that uses discrete signals represented in binary code. For example, the data conversion may be performed by assigning a binary value to each variable of the plurality of variables, wherein each variable is a categorical value, a numerical value, or an ordinal value, by generating, using the binary value of each variable, an index for each data type and each entity of the plurality of entities and by storing each index in a database. The plurality of indexes help identify potential bars on career advancement and may forecast the career trajectory of members of the organization. The transformed data 1805 undergoes a second data transformation 1803, as described above. In some embodiments, visualization signals 1804 from the processor may be sent to the graphical user interface (GUI) 1806. In other embodiments, the visualization signal facilitates the visualization of large data set in a way that allows a user to understand the data. For example, the processor may retrieve attrition data from HR, transform the data, and send a visualization signal for the GUI to display a graph to show the attrition rate of male and female employees in the same job role. The GUI 1806 displays the transformed data to the user with different output options. In some embodiment, the output is shown in various formats, such as graphs, videos, images, or plain text. Members of the organization may then access and analyze the data.

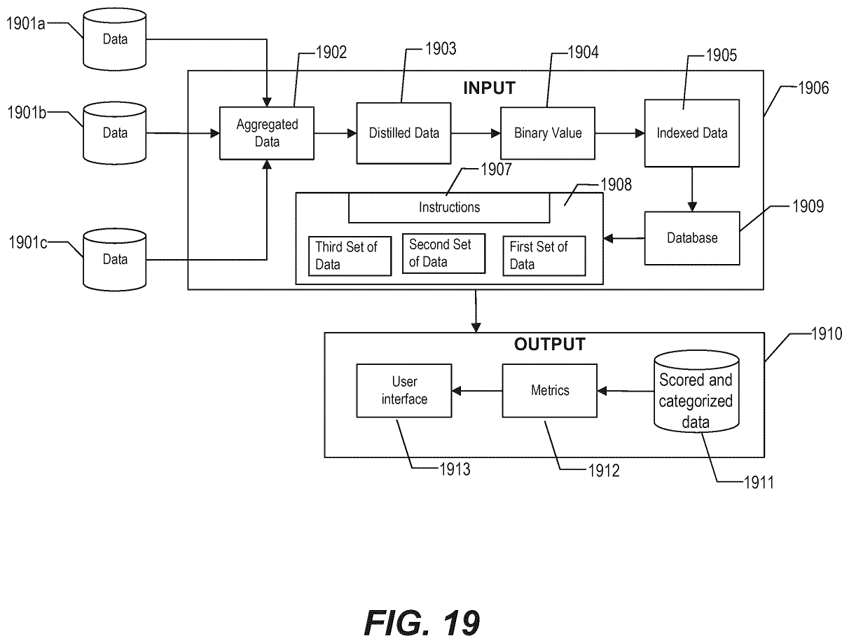

FIG. 19 illustrates the flow of data received from a plurality of disparate data sources 1901a, 1901b, and 1901c. In some embodiments, the data may include a plurality of variables, wherein each variable of the plurality of variables is associated with a data type and an entity of a plurality of entities. The flow of data may include aggregating 1902 the data and distilling 1903 the data into a plurality of indexes to convert the data to be usable by a single data structure. In some embodiments, a binary value 1904 is assigned to each variable of the plurality of variables, wherein each variable may be a categorical value, a numerical value, or an ordinal value, by generating, using the binary value of each variable, an index 1905 for each data type and each entity of the total plurality of entities and by storing each index in a database 1909. In other embodiments, the operations described above may be performed by at least one processor 1908 configured to execute instructions in a system for identifying a velocity model for a plurality of positions and predicting outcomes for the plurality of positions. In such embodiments, each data set undergoes a mathematical transformation by at least one processor configured to execute instructions 1907, by calculating a mean, median or other type of statistical or numerical value, of the categorical variables that include the velocity index, attrition, and network analytic index. For example, the operations may include retrieving a first set of data elements associated with the plurality of entities from the plurality of indexes, wherein the first set of data elements includes information associated with a velocity index, attrition, and network analytic index. Similarly, the operations may also include generating a second probability of moving to a second different position for each of the plurality of entities. The second probability may be calculated by a second mathematical transformation that includes the velocity index, attrition, and network analytic index. The transformed data 1911 may be categorized or grouped based on specific criteria or characteristics, numerical information and/or statistical data type. The output may be the transformation of the data that can be presented to a user via a user display. 1910. The transformed data may be incorporated into the systems and methods disclosed herein to generate metrics 1912 at given points throughout the employment of an employee and transfer those metrics about specific individuals into an interactive user interface 1913 for organizations to systematically identify key metrics specific to members of protected classes or the organization at large.

FIG. 20 illustrates a flow chart 2000 showing the flow of initial data from a plurality of disparate data sources to attrition scores that may be flagged from a plurality of individuals at step 2009. At step 2001, the operations may include receiving data available to the organization from a plurality of disparate data sources. The data may include a plurality of variables, wherein each variable of the plurality of variables is associated with a data type and an entity of a plurality of entities in a position. The set of data elements may include information associated with at least one of tenure, years in the job role, age, commute distance, performance, and payroll data. The set of data elements may also include backlogged or unused data available to the organization, such as commute distance and time. For example, an organization may flag a plurality of employees with a similar commute distance with an unfavorable attrition score. Once these employees are flagged, the organization may implement a plan to reduce the commute distance for the flagged employees to promote retention of these employees.

At step 2002, the operations may further include distilling the data into a plurality of indexes. The distilling may convert the data into a plurality of indexes to be usable by a single data structure. The distilling may convert the data into a plurality of indexes to be usable by a single data structure. The data conversion may be performed by assigning a binary value to each variable of the plurality of variables, wherein each variable is a categorical value, a numerical value, or an ordinal value, by generating, using the binary value of each variable, an index for each data type and each entity of the plurality of entities and by storing each index in a database. At step 2003, a set of data may be retrieved from the plurality of indexes associated with a plurality of individuals in the job role. For example, data pertaining to information associated with at least one of tenure, years in the job role, age, commute distance, performance, or payroll may be retrieved from the plurality of indexes associated with a plurality of individuals in a job role.

At step 2004, an attrition index score may be assigned to each set of information included in the set of data elements. For example, when analyzing the data pertaining to commute time for a plurality of employees in the same job role, a shorter commute may garner a more favorable attrition score than a longer commute. An attrition model algorithm may be stored as instructions in a non-transitory computer readable medium and may be used to determine an attrition threshold for the plurality of individuals in a job role. The non-transitory computer readable medium may include at least one processor that executes the attrition model algorithm to predict attrition of employees in a job role. The data conversion may be performed by assigning a binary value or score to each variable of the plurality of variables, wherein each variable is a categorical value, a numerical value, or an ordinal value, by generating, using the binary value of each variable, an index for each data type and each entity of the plurality of entities and by storing each index in a database. The operations may further comprise predicting, using the attrition index, attrition for each entity of the plurality of entities, wherein the attrition is a binary event.

At step 2005, an organization may determine an attrition threshold for the plurality of individuals in a job role based on the attrition score assigned to each of set of information included in the set of data elements. The attrition threshold may be the number or value associated with a set of data elements where the organization sees the most attrition. For example, employees with commutes longer than an hour may have a higher rate of attrition than employees with commutes of less than 15 minutes; therefore, a one hour commute may be the attrition threshold associated with employee commutes.

At step 2006, the non-transitory computer readable medium may include at least one processor that executes the attrition model algorithm described previously to determine an attrition score for each of the plurality of individuals in a job role to predict attrition of employees in that job role. For example, individuals with commutes longer than an hour may have a more unfavorable attrition score than individuals with commutes of less than 15 minutes. These attrition score may help an organization identify individuals at high risk of attrition.

At step 2007, an organization may compare the attrition scores of each of the plurality of individuals to the attrition threshold. The operations may further include creating a distribution of attrition for the position, as described in FIG. 10, wherein the distribution uses the attrition of each entity of the plurality of entities. The distribution may include the attrition indexes. The operations may further include generating, using the distribution, a quantity of a projected plurality of entities in the position over a duration of time. The operations may further include generating a visualization of the distribution. The distribution may use the likelihood of attrition of each of the plurality of individuals. The operations may further comprise generating, using the distribution, a quantity of a projected plurality of entities in the position over a duration of time. The operations may further comprise generating a visualization of the distribution.

At step 2008, attrition scores may be compared to the attrition threshold. Attrition scores greater than the attrition threshold may be systematically identified to predict attrition or promote retention in an organization. For example, a high attrition score associated with commute time may be identified if it is greater than the attrition threshold of the organization.

At step 2009, an organization may flag the individual associated with the high attrition score to mitigate the impact of the high attrition score and to develop a plan to retain such employees. For example, an organization may make transportation or housing arrangements for an individual that was flagged for having a commute longer than an hour, which is longer than the attrition threshold for employee commute.

FIG. 21 illustrates a flow chart 2100 showing the flow of initial data from a plurality of disparate data sources to calculate talent flight probability that may be used to identify one or more entities or individuals from a plurality of entities or individuals who represent top talented employees with a high probability of leaving the organization.

At step 2102, data available to the organization may be received from a plurality of disparate data sources. The data may include a plurality of variables, wherein each variable of the plurality of variables is associated with a data type and an entity of a plurality of entities in a position. The initial data may include information associated with at least one of tenure, years in the job role, age, commute distance, commute time, performance, or payroll data. The initial data may also include backlogged or unused data available to the organization, such as commute distance and time. For example, backlogged data may include data collected about employees or entities at an organization by the organization that has accumulated over time, e.g., over the tenure of one or more employees, that has not been processed or reviewed by the system. For example, unused data may refer to information collected about employees or entities at an organization that has not been processed or utilized for metrics or predictions prior to the system described herein. For example, the system or method may flag, or identify, a plurality of employees with a similar commute distance with an unfavorable flight risk score and a high-performance score. For example, a flagged individual may be an individual that is selected based one or more criteria. A “flag” or mark may be added to the employee's file with resources, management, or within the system described here. A flag may allow system oversight or management of the organization to quickly identify employees fitting the criteria assigned to the flags. For example, an employee may be flagged or identified for one or more criteria determined by the system or the organization. Once these employees are flagged, an organization may implement a plan to reduce the commute distance for the flagged employees to promote retention of these high-performing employees.

According to some embodiments, the plurality of disparate data sources may include, one or more first input datasets, one or more second input datasets, individual performance monitoring, team monitoring, and market monitoring. Team monitoring may include employee turnover within a team, team composition, or team dynamics and inter-team connections. Market monitoring may include market data regarding job performances outside of the organization or within the organization, the need for employees in the market, the volatility of the market, or market turnover. The first and second input datasets may include any collected information, as discussed below. The plurality of disparate data sources may include information associated with employee peer-to-peer recognition, manager-to-employee recognition, an employee's outstanding equity in the organization, changes in management above the employee, and organizational risk factors.

For example, employee peer-to-peer recognition may include the business practice of colleagues acknowledging and appreciating each other's contributions, efforts, and achievements in the workplace. Employee peer-to-peer recognition may include structured business initiatives that encourage employees to recognize one another through platforms or tools designed for the purpose. Employee peer-to-peer recognition data may be associated with an individual employee who performs at an above-average level compared to their peers. An individual employee who performs at an above-average level compared to their peers and is recognized through the employee peer-to-peer recognition system may have a lower talent flight risk score if the employee feels that their contribution is valued by the organization.

Organizational risk factors may include data elements that are not directly correlated to an individual employee's performance but are associated with the organization or team to which the individual employee reports or belongs. Organizational risk factors may include data related to the organization's employee turnover or churn, data related the individual employees' engagement in their organization or team, and data related to individual employees' level of adherence to in-office policies.

An organization's employee turnover or churn may refer to the rate at which employees leave an organization and are replaced by new hires. This may include voluntary departures, such as resignations, and involuntary separations, like layoffs or terminations. A high-rate employee turnover or churn may indicate underlying issues within the workplace, such as low job satisfaction, poor management, or inadequate compensation.

Data related to the individual employees' engagement in their organization or team may include metrics and indicators that reflect how connected and committed individual employees feel to their organization or team. Data related to the individual employees' engagement in their organization or team may include: surveys and questionnaires related to feelings about job satisfaction, alignment with company values, and overall morale; net promoter scores, which may measure how likely employees are to recommend their workplace to others, which may indicate an employee's overall satisfaction and loyalty; participation data may include data related to how many employees participate in engagement initiatives, such as surveys, training programs, or team-building activities; frequent absenteeism rates may be related to an employee's disengagement, reflecting a lack of motivation or satisfaction with the work environment; career development participation and professional development opportunities may indicate employees' commitment to growth within the organization.

Data related to an employee's level of adherence to in-office policies may refer to how well employees follow the established guidelines and protocols set by an organization for behavior and operations within the workplace. This data may include attendance, dress code, health and safety regulations, communication standards, and use of company resources.

The data may include a first plurality of variables associated with one entity of a plurality of entities in a position of a plurality of positions. For example, the first plurality of variables may include information about each of the entities, including, for example, each entity's demographic information, each entity's organizational engagement, each entity's team engagement, each entity's tenure with the organization, and other information regarding each entity, as described above. According to some embodiments, the plurality of positions may include one or more employment or levels within the organization. For example, some positions may include bank teller, receptionist, level 1 manager, legal representative, and senior executive.

According to some embodiments, the data may further include a second plurality of variables associated with a performance metric of a plurality of performance metrics associated with the each of the plurality of entities. For example, the second plurality of variables may include each entity's performance scores as assigned by a manager review, each entity's predicted performance metrics obtained by monitoring an entity, and other data associated with an entity's job performance, as described above.

At step 2104, the data may be distilled into a plurality of indexes, i.e., a plurality of indexes may be generated from the data. The distilling may convert the data into a plurality of indexes to be usable by a single data structure. For example, indexing may include organizing the data into a plurality of rows and columns such that the system or operations may access specific entries in the indexes. For example, the plurality of indexes may be used for filtering or selecting subsets of data based on certain conditions. For example, specific subsets of data may be filtered to certain rows where the value in a column exceeds a threshold. For example, indexing may allow the system to select features, or independent variables from which associations are drawn; select target labels, e.g., the resultant dependent variables; or split the data into training and testing sets for a machine learning algorithm to process the data and learn from the data.

According to some embodiments, distilling the data into a plurality of indexes may include combining different datasets that may have different structures or formats and creating a unified index to allow efficient access and manipulation. According to some embodiments, distillation may include identifying common columns or keys between the disparate datasets that can be used for indexing, for example, IDs, timestamps, or other identifiers that allow the data for be joined or merged. According to some embodiments, distillation may include standardizing the data into a uniform format to create a consistent indexing system. According to some embodiments, distillation may include merging the datasets. In this process, an index that aligns the data from each of the disparate sources may be formed.

The data conversion may be performed by assigning a binary value to each variable of the plurality of variables, wherein each variable is a categorical value, a numerical value, or an ordinal value, by generating, using the binary value of each variable, an index for each data type and each entity of the plurality of entities and by storing each index in a database.

According to some embodiments, the plurality of indexes may be data structures that facilitate and accelerate search operations. For example, given a query, the plurality of indexes may locate the block where a particular record resides in memory. This structure may allow for a more systematic query evaluation, accessing the portion of the data corresponding to each of the plurality of indexes. The plurality of indexes may be a dense index, which keeps an entry for every search key value, or sparse index, which keeps entries for only a subset of values. According to some embodiments, one or more of the plurality of indexes may be a multi-level index having a hierarchical structure. For example, the first level of a multi-level index may comprise a sparse index which points to ordered data therein. For example, every subsequent level in a multi-level index comprise a sparse index on top of the previous level, which may use of only a relevant fraction of the indexes during a query. According to some embodiments, each of the plurality of indexes may be a B-tree index, a Hash table, or Bloom filter.

The plurality of indexes may include: a first index associated with the plurality of positions; a second index associated with the plurality of entities; a third index associated with one or more characteristics associated with each of the plurality of entities; and a fourth index associated with the plurality of performance metrics.

According to some embodiments, the first index associated with the plurality of positions may be an index that allows for search queries and organization of the datasets by the position one or more entities' hold within the organization. For example, the first index may facilitate locating the records of entity's based on their position within the organization. The second index associated with the plurality of entities may be an index that allows for reference to the datasets with respect the specific entities. The third index associated with one or more characteristics associated with each of the plurality of entities may relate to demographic information of each of the entities, as described above. The fourth index associated with one or more performance metrics associated with each of the plurality of entities may relate to the performance, both collected and monitored, as described above.

At step 2106, one or more associations may be extracted from the plurality of indexes. The one or more associations may be predictions made by the system based on the one or more input datasets and one or more second input datasets. The plurality of indexes may assist in the formation of the associations based on the organization of the data. For example, data pertaining to information associated with at least one of tenure, years in the job role, age, commute distance, performance, or payroll may be retrieved from the plurality of indexes associated with a plurality of individuals in a job role. For example, data pertaining to information associated with at least one of employee peer-to-peer recognition, manager-to-employee recognition, an employee's outstanding equity in the organization, changes in management above the employee, and organizational risk factors may be retrieved from the plurality of indexes associated with a plurality of individuals in a job role.

In some embodiments, the associations may include one or more probabilistic distributions based on a relationship between each of the plurality of performance metrics and each of the plurality of positions. For example, the plurality of performance metrics may include data gathered from the plurality of disparate data sources. For example, performance metrics may include the time an entity takes to complete a task, such as completing a project; how many times an entity's work product needs correction before completion; the quantity of work produced (e.g., units completed, projects delivered) by an entity; a percentage of tasks or projects completed on time versus assigned tasks; absenteeism rate; punctuality; customer feedback (e.g., surveys or customer reviews); time taken to resolve customer issues; team contribution; competency levels; innovative ability; problem-solving ability; autonomy when completing a task; time management; task prioritization; peer-reviews; manager reviews; and self-evaluations.

According to some embodiments, a machine learning algorithm may create the associations including one or more probabilistic distributions. According to some embodiments, a machine learning algorithm may leverage the plurality of indexes of the one or more input databases and the one or more second input databases to identify and extract relationships or patterns among variables or data points.

According to some embodiments, the machine learning algorithm may be a supervised learning model that uses the plurality of indexes. The machine learning algorithm may be, for example, a linear regression model, a decision trees, or a neural network. According to some embodiments, the machine learning algorithm use training data, for example a portion of the plurality of datasets. The algorithm may adjust internal parameters, e.g., weights in neural networks in order to minimize the error or difference between the predictions and the actual values. According to some embodiments, this may utilize an optimization process, such as gradient descent, where the machine learning algorithm iteratively adjusts its parameters to reduce a loss function. The machine learning algorithm's parameters may be updated repeatedly, based on feedback from the training data, to improve the accuracy over time. According to some embodiments, the machine learning algorithm may use data related to entities who previously left the organization to form associations between the characteristics of the departed entities and the likelihood of the entity leaving the organization.

For example, extracting one or more associations may include association rule mining in which the machine learning algorithm forms relationships or patterns between variables, for example between an entity's commute time and their likelihood of leaving the organization. In a dataset, each row can be thought of as a transaction or a data point with features that can form associations with other features. According to some embodiments, the plurality of indexes, such as entity ID or characteristic identifier, may keep track of which entities (or characteristics) appear together, allowing associations to be extracted from the disparate data.

According to some embodiments, the one or more associations may be extracted from the datasets using clustering associations, wherein data points are grouped based on their similarities. After clustering, the plurality of indexes may track which data points belong to which cluster. Associations may be extracted by observing common patterns within the clusters.

According to some embodiments, extracting the one or more associations may include identifying one or more indicia related to the at least one of: one or more input datasets, one or more second input datasets, individual performance monitoring, team monitoring, and market monitoring; and wherein the one or more indicia are associated historical conditions related to employee turnover. The one or more indicia may be signals or flags that have a high correlation between a characteristic of an entity and the likelihood of the associated entity leaving. For example, the one or more indicia may mark or indicate certain conditions or categories in the input datasets. The indicia may be identified by the machine learning algorithm based on predicted relationships or patterns in the data.

For example, the one or more probabilistic distributions may represent trends and associations between different entity characteristics and the probability that the associated entity is high performing. For example, the one or more probabilistic distributions may represent trends and associations between different entity characteristics and the probability that the entity will leave the organization. Each of the one or more associations may include one or more probabilistic distributions based on the relationship between each of the plurality of performance metrics and each of the plurality of positions. Once the machine learning algorithm is trained, it may be deployed to form associations. The machine learning algorithm can make predictions on new data, for example, an entity who has not left the organization but performs well within their role. According to some embodiments, the one or more associations may be extracted through a feature selection process, where the plurality of indexes identifies which features or characteristics of an entity are most strongly associated with a target variable, for example high performance or high likelihood of leaving the organization. According to some embodiments, the plurality of indexes may be used to organize the data in order to efficiently extract associations between features and the target variables. According to some embodiments, the probabilistic distributions may be formed by the machine learning algorithm trained on the data received in step 2102. According to some embodiments, the probabilistic distributions may represent a distribution of the likelihood of all entities of the organization leaving the organization. The probabilistic distributions may represent a distribution of all of the entities' performance at the organization, thereby showing how the entities' performance ranges across the workforce.

According to some embodiments, creating a distribution of flight probability for each of the plurality of positions, wherein the distribution uses the flight index for each entity of the plurality of entities. This distribution may help the system or the organization pinpoint characteristics that lead to a higher likelihood of entities departing the organization. From the distribution, a quantity of identified entities may be generated, where the quantity of identified entities have a flight index higher than a threshold flight probability in each of the plurality of positions over a duration of time. In this way, the system may predict a number of employees with a high probability of leaving the organization over a period of time. According to some embodiments, a characteristic flight probability metric may be extracted based on the quantified entities and the third index. The characteristic flight probability metric may be a metric or flag that identifies one or a set of characteristics from the initial data and the datasets. This one or set of characteristics may be highly correlated with the likelihood of a number of entities leaving the organization. The characteristic flight probability metric may be used to identify specific characteristics of the entities which raises concern regarding the entity's tenure at the organization.

At step 2108, a flight index for each of the entities may be generated based on each of the plurality of entities, the associated performance metrics, and the extracted one or more associations. For example, the flight index may represent a statistical measure of a likelihood that the associated entity will change from the associated entity's current position within an organization to one or more new positions outside of the organization. For example, a flight index may be generated based on each of the plurality of entities and the associated performance metrics. For example, when analyzing the data pertaining to organizational engagement for a plurality of employees in the same job role, an employee who has a higher level of engagement with their team may have a higher level of loyalty to their organization and sense of satisfaction with their role in the organization. This may result in a lower flight index than an employee who has a lower level of engagement with their team or organization. The flight index for each of the entities may be used in step 2112 to form a threshold flight probability and may also be used in step 2114 to generate a flight probability.

At step 2110, a performance index for each of the entities may be generated based on each of the plurality of entities, the associated performance metrics, and the extracted one or more associations. For example, the performance index may represent a statistical measure of a likelihood that the associated entity is higher performing than the entity's peers. For example, a performance index may be generated based on each of the plurality of entities and the associated performance metrics. The performance index for the plurality of individuals in a job role may be based on the plurality of indexes associated with the plurality of individuals in the job role. The performance index may be associated with each individual employee.

In some embodiments, the performance index may include performance markers for employees. Performance markers may be indicators or traits in the plurality of indexes that correlate to strong performance and productivity in the organization. Performance markers may include: an employee consistently meeting or exceeding individual and team targets demonstrates effectiveness and dedication; an employee producing high-quality work with attention to detail, accuracy, and creativity, which reflects commitment and skill; an employee showing improvements or taking on additional responsibilities, which shows engagement and leadership potential; an employee contributing to team projects or supporting colleagues; an employee pursuing professional development opportunities or seeking feedback; and an employee prioritizing tasks effectively and meeting deadlines consistently, which reflects strong organizational skills.

At step 2112, a threshold flight probability for the plurality of individuals in a job role may be determined based on the flight index assigned to each of entities or individuals. The threshold flight probability may be a threshold value or number identified by the system and the machine learning algorithm that corresponds to an unacceptable risk of an entity leaving the organization. For example, entities with an engagement with their organization above a calculated hours per quarter may have a lower threshold flight probability than entities with a lower number of hours per quarter spent engaging with their organization; therefore, the calculated hours may be the flight risk threshold associated with entities organizational engagement. According to some embodiments, the threshold flight probability may be the acceptable risk calculated by the machine learning algorithm that an entity will leave the organization. For example, a threshold flight probability may be 80%, meaning that the risk of an entity leaving the organization must be greater than 80% for the entity to be considered an actionable loss for the organization to take corrective measures.

At step 2114, the flight indexes may be compared to each of the performance indexes to generate a flight probability for each entity. The machine learning algorithm may utilize the comparison in step 2114 to determine individuals who have high a performance index and a high flight index to determine the greatest talent loss risk to the organization. According to some embodiments, the performance index and the flight index for the entities may be compared such that higher performing entities have a higher flight probability because those entities are more valuable to the organization.

At step 2116, risk of employees in a job role leaving the organization is predicted. The machine learning algorithm described above, for example, with respect to step 2106, may identify one or more entities having an associated flight probability higher than the threshold flight probability. For example, an association extracted in step 2106 may reveal that entities with less hours spent engaging with the organization and a very high-performance score may have a higher flight probability than entities with more hours of engagement with the organization and the same level of performance. Thus, the machine learning algorithm may be able to identify entities having a high performance and high value to the organization and a higher probability of leaving the organization. As a further example, individuals with less hours spent engaging with the organization and a low performance score may have a lower flight probability than individuals with the same low hours of engagement with the organization and a high level of performance. The organization may wish to prevent talented employees from leaving the organization. Thus, the extracted associations, flight index, and performance index may identify valuable employees likely to be lost by the organization. The flight indexes may help an organization identify high performing individuals at higher probability of leaving the organization. For example, top performing employees who present a high predicted flight risk may be flagged based on a number of organizational risk factors in comparison to other employees in the same role at the organization.

At step 2118, one or more policy changes within the organization, based on the identification, may be implemented to the existing policies of an organization. For example, one or more policy changes may comprise a set of rules that are removed from the employee requirements. For example, the one or more changes to one or more policies may be configured to reduce the statistical likelihood that the one or more chosen entities will change from a current positions of the one or more chosen entities current position within the organization to one or more new positions outside of the organization.

For example, policy changes may include competitive compensation and benefits, which may include salary reviews and adjustments, or benefits packages. For example, policy changes may include flexible work arrangements, which may include remote or hybrid work options to allow employees to choose between in-office, hybrid, or fully remote work options based on their preferences and roles; flexible hours; unlimited paid time off (PTO) instead of fixed PTO. For example, policy changes may include increased career development and growth opportunities, which may include, training and development programs such as offer ongoing learning opportunities; establishing clear, attainable career progression paths and regular performance reviews to discuss advancement opportunities; or mentorship programs. For example, policy changes may include employee recognition and appreciation. For example, policy changes may include an inclusive and supportive work environment, which may include strengthening employee initiatives and policies, implementing and enforcing, creating opportunities for employees to connect through resource groups based on shared interests, backgrounds, or professional development. For example, policy changes may include providing parental leave, flexible scheduling for family needs, and support for employees balancing family and work life; access to mental health services, stress management workshops; encouraging time away from work to encourage employees to fully disconnect from work during weekends and vacations to prevent burnout. For example, policy changes may include leadership and management development, employee feedback channels, and promoting internal mobility. For example, policy changes may include job security and stability, including informing employees about company performance, challenges, and strategies for growth. For example, policy changes may include employee surveys and feedback mechanisms, team building activities, increasing employee autonomy. For example, policy changes may include investing in technology and tools for efficiency.

At step 2120, the flight index of one or more identified entities over a period of time may be monitored based on the policy changes. For example, steps 2108 through 2118 may be repeated after a period of time elapses from when the policy changes of step 2118 where implemented. According to some embodiments, entities' flight index may be recalculated iteratively as time passes to monitor whether the policy changes reduce the likelihood of entities leaving the organization. For example, the monitoring may enable an organization to evaluate whether the changes implemented have increased the probability that an employee with stay with the organization. According to some embodiments, monitoring may include constant, iterative, or repetitive collection of the data from the plurality of disparate data sources such that employee performance and retention may be improved. In this way, method 2100 may improve employee retention and allow an organization to tailor its policies to retain top talent and increase parity in its workforce.

According to some embodiments, the system may generate a visualization of the distribution. Composition of entities in a position may include the mix of the workforce in the position based on factors such as age, gender, education level, experience, and job role. Based on the prediction of the number of entities that may be expected to leave the organization, the expected composition may be calculated. The expected composition may include the characteristics of the entities in a position or a plurality of positions. For example, an expected employee composition of the organization may be generated based on the prediction of the number of new hires and associated demographic traits. In some embodiments, the operations may further comprise displaying a visualization of the expected composition. In some embodiments, the operations may further comprise displaying a visualization of the expected composition of entities predicted to depart from the organization.

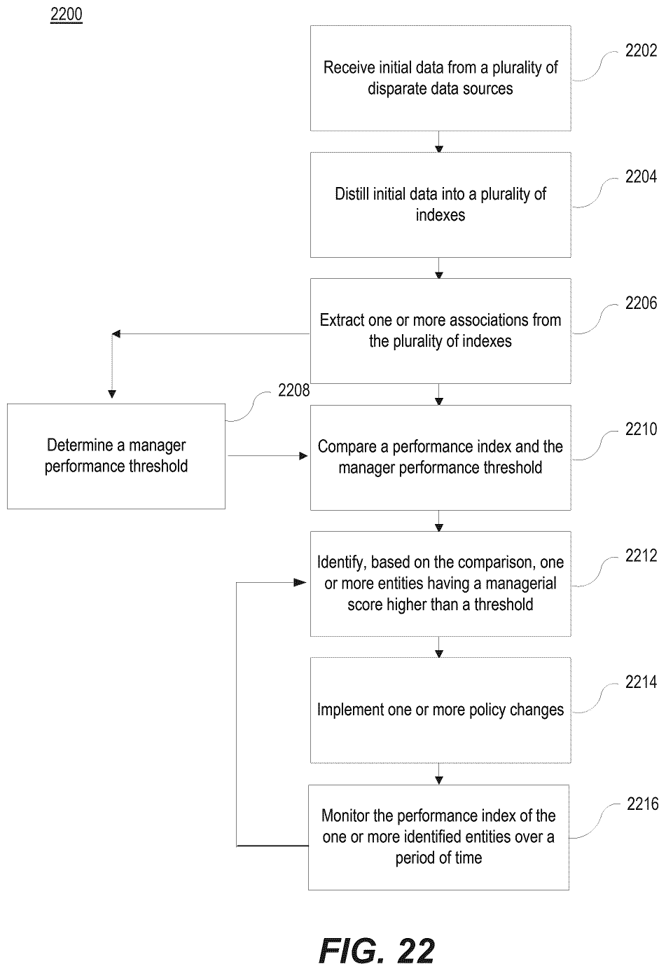

FIG. 22 illustrates a flow chart 2200 showing the flow of initial data from a plurality of disparate data sources to identify one or more managers performing above a manager score threshold in order to identify one or more managers in need of retraining.

At step 2202, data may be received from a plurality of disparate data sources. The data may include a plurality of variables, wherein each variable of the plurality of variables is associated with a data type and an entity of a plurality of entities in a position. The initial data may include information associated with at least one of tenure, years in the job role, age, commute distance, commute time, performance, and payroll data. The initial data may include information associated with managerial review quality, an amount of employee relations cases, employee turnover within a manager's organization or team, leadership reviews from mangers, and leadership reviews from direct reports.

The initial data may also include backlogged or unused data available to the organization, such as commute distance and time. For example, backlogged data may include data collected about employees or entities at an organization by the organization that has accumulated over time, e.g., over the tenure of one or more employees, that has not been processed or reviewed by the system. For example, unused data may refer to information collected about employees or entities at an organization that has not been processed or utilized for metrics or predictions prior to the system described herein. For example, the system or method may flag, or identify, a plurality of employees in a managerial role with different engagement levels within the organization and employees in a managerial role with high scores awarded to their subordinates. For example, a flagged individual may be an individual that is selected based one or more criteria. A “flag” or mark may be added to the employee's file with human resources, management, or within the system described here. A flag may allow system oversight or management of the organization to identify quickly employees fitting the criteria assigned to the flags. For example, an employee may be flagged or identified for one or more criteria determined by the system or the organization. Once these employees are flagged, an organization may implement a plan to improve engagement with the organization for the one or more flagged employees.

For example, the data may include a first and second plurality of variables. For example, the plurality of disparate data sources may include, one or more first input datasets, one or more second input datasets, individual performance monitoring, team monitoring, and market monitoring. Team monitoring may include employee turnover within a team, team composition, or team dynamics and inter-team connections. Market monitoring may include market data regarding job performances outside of the organization or within the organization, the need for employees in the market, the volatility of the market, or market turnover. The first and second input datasets may include any collected information, as discussed above.

Each of the first plurality of variables may be associated with one entity of a plurality of entities in a managerial position of a plurality of managerial positions. Each of the second plurality of variables may be associated with a performance metric of a plurality of performance metrics associated with each of the plurality of entities. The plurality of disparate data sources may include at least one of: one or more input datasets, one or more second input datasets, individual performance monitoring, team monitoring, and market monitoring, as described above with respect to FIG. 21. For example, the first plurality of variables may include information about each of the entities in a managerial position, including, for example, each entity's demographic information, each entity's organizational engagement, each entity's team engagement, each entity's tenure with the organization, and other information regarding each entity, as described above. According to some embodiments, the plurality of positions may include one or more employment or levels within the organization. For example, some positions may include any level of manager, legal managers, and senior executive.

According to some embodiments, the data may further include a second plurality of variables associated with a performance metric of a plurality of performance metrics associated with the each of the plurality of entities. For example, the second plurality of variables may include each entity's performance scores as assigned by a manager review, each entity's predicted performance metrics obtained by monitoring an entity, the quality of the review given by the manager, i.e., managerial review quality, employee relation cases, employee turnover, and other data associated with an entity's job performance, as described above.

For example, managerial review quality may refer to the length of a review a manager gives to an employee, or to keywords identified through a text mining process. Text mining may include extracting useful information and insights from unstructured text data. Text mining may combine techniques from natural language processing (NLP), machine learning, and statistics. Text mining may analyze and interpret textual information in managerial review to identify keywords associated with high quality reviews. Managerial review quality may be related to the content of the review, include a depth of information which may ensure that employees understand the basis of the evaluation. Managerial review quality may be related to how specific a review is, or to how detailed the review discussed particular behaviors or outcomes. Managerial review quality may be related to how much constructive criticism is provided in the review, and may include whether actionable suggestions are included. Managerial review quality may be related to acknowledging strengths and achievements of the employee.

For example, employee relation cases may refer to cases involving managers which arise from conflicts, misunderstandings, or grievances between employees and managers. Employee relation cases may include: conflict resolution where two employees have a disagreement that affects team dynamics; performance issues where an employee is underperforming and not meeting expectations; discrimination complaints where an employee feels they are being discriminated against based on race, gender, or other protected characteristics; harassment allegations, where an employee reports harassment from a colleague or manager; workplace bullying, where an employee experiences bullying behavior from a manager or another employee; and organization policy violations, where an employee violates company policy, as described above. For example, managers with more employee relation cases related to allegations of manager grievances may correlate to a poorly performing manager.

For example, employee turnover within a manager's organization or team may refer to a high number of employees may refer to the rate at which employees leave an organization and are replaced by new hires. A high employee turnover may be correlated to increased organizational costs, loss of institutional knowledge, and disruptions in team dynamics. A high employee turnover may be related to a poorly performing manager.

For example, leadership reviews from managers and leadership reviews from direct reports may include reviews by subordinates and supers of a manager and may include assessments of a leader's performance, effectiveness, and impact within an organization. A leadership review may include formal evaluations, 360-degree feedback, or informal discussions. 360-degree feedback may include a comprehensive assessment to gather feedback about a manager's performance from multiple sources. The multiple sources may include input from various stakeholders such as peers, subordinates, supervisors, and customers. Leadership reviews may include evaluating a manager against specific performance indicators, which may include team goals, project outcomes, and overall organizational impact. Leadership reviews may include evaluating leadership qualities, which may include a manager's communication skills, decision-making, conflict resolution, and ability to inspire and motivate others.

At step 2204, the data may be distilled into a plurality of indexes, i.e., a plurality of indexes may be generated from the data. The distilling may convert the data into a plurality of indexes to be usable by a single data structure. The distilling may convert the data into a plurality of indexes to be usable by a single data structure. The data conversion may be performed by assigning a binary value to each variable of the plurality of variables, wherein each variable is a categorical value, a numerical value, or an ordinal value, by generating, using the binary value of each variable, an index for each data type and each entity of the plurality of entities and by storing each index in a database.

For example, indexing may include organizing the data into a plurality of rows and columns such that the system or operations can access specific entries in the indexes. For example, the plurality of indexes may be used for filtering or selecting subsets of data based on certain conditions. For example, specific subsets of data may be filtered to certain rows where the value in a column exceeds a threshold. For example, indexing may allow the system to select features, or independent variables from which associations are drawn; select target labels, e.g., the resultant dependent variables; and split the data into training and testing sets for a machine learning algorithm to process the data and learn from the data.

According to some embodiments, distilling the data into a plurality of indexes may include combining different datasets that may have different structures or formats and creating a unified index to allow efficient access and manipulation. According to some embodiments, distillation may include identifying common columns or keys between the disparate datasets that may be used for indexing, for example, IDs, timestamps, or other identifiers that allow the data for be joined or merged. According to some embodiments, distillation may include standardizing the data into a uniform format to create a consistent indexing system. According to some embodiments, distillation may include merging the datasets. In this process, an index that aligns the data from each of the disparate sources may be formed. The plurality of indexes may be stored in a database.

The plurality of indexes may include: a first index associated with the plurality of managerial positions; a second index associated with the plurality of entities; a third index associated with one or more performance metrics associated with each of the plurality of entities.

According to some embodiments, the first index associated with the plurality of positions may be an index that allows for search queries and organization of the datasets by the position one or more entities' hold within the organization. For example, the first index may facilitate locating the records of entity's based on their position within the organization. The second index associated with the plurality of entities may be an index that allows for reference to the datasets with respect the specific entity. The third index associated with one or more performance metrics associated with each of the plurality of entities may relate to the performance, both collected and monitored, as described above.

At step 2206, one or more associations may be extracted from the plurality of indexes. The one or more associations may be predictions made by the system based on the one or more input datasets and one or more second input datasets. The plurality of indexes may assist in the formation of the associations based on the organization of the data. For example, each of the one or more associations includes one or more probabilistic distributions based on a relationship between each of the plurality of performance metrics and each of the plurality of managerial positions. For example, associations pertaining to information associated with at least one of tenure, years in the job role, age, commute distance, performance, or payroll may be retrieved from the plurality of indexes associated with a plurality of individuals in a manager role. For example, associations pertaining to information associated with at least one of managerial review quality, an amount of employee relations cases, employee turnover within a manager's organization or team, leadership reviews from mangers, and leadership reviews from direct reports may be retrieved from the plurality of indexes associated with a plurality of individuals in a manager role.

For example, the plurality of performance metrics may include data gathered from the plurality of disparate data sources. For example, performance metrics may include the time an entity takes to complete a task, such as completing a project; how many times an entity's work product needs correction before completion; the quantity of work produced (e.g., units completed, projects delivered) by an entity; a percentage of tasks or projects completed on time versus assigned tasks; absenteeism rate; punctuality; customer feedback (e.g., surveys or customer reviews); time taken to resolve customer issues; team contribution; competency levels; innovative ability; problem-solving ability; autonomy when completing a task; time management; task prioritization; peer-reviews; manager reviews; and self-evaluations. For example, performance metrics may include the performance of the employees which each entity in a managerial position supervises.

For example, each of the one or more associations may include one or more probabilistic distributions based on the relationship between each of the plurality of performance metrics and each of the plurality of managerial positions. According to some embodiments, the probabilistic distributions may be formed by a machine learning algorithm trained on the data acquired in step 2202, or from historical data relating to managerial performance, or both.

According to some embodiments, a machine learning algorithm may leverage the plurality of indexes of the one or more input databases and the one or more second input databases to identify and extract relationships or patterns among variables or data points.

According to some embodiments, the machine learning algorithm may be a supervised learning model that uses the plurality of indexes, as described above with reference to FIG. 21.

According to some embodiments, extracting the one or more associations may include identifying one or more indicia related to the at least one of: one or more input datasets, one or more second input datasets, individual performance monitoring, team monitoring, and market monitoring; and wherein the one or more indicia are associated historical conditions related to manger performance and employee turnover. The one or more indicia may be signals or flags which have a high correlation between a characteristic of an entity and the likelihood of the entity being a high or low performing manager. For example, the one or more indicia may mark or indicate certain conditions or categories in the input datasets. The indicia may be identified by the machine learning algorithm based on predicted relationships or patterns in the data.

For example, the one or more probabilistic distributions may represent trends and associations between different entity characteristics and the probability that the associated managerial entity is high performing. Each of the one or more associations may include one or more probabilistic distributions based on the relationship between each of the plurality of performance metrics and each of the plurality of positions. Once the machine learning algorithm is trained, it may be deployed to form associations. The machine learning algorithm may make predictions on new data, for example, a manager who has not yet been evaluated to predict their performance with respect to their employees. According to some embodiments, the one or more associations may be extracted through a feature selection process, where the plurality of indexes identifies which features or characteristics of an entity are most strongly associated with a target variable, for example high performance or high likelihood of leaving the organization.

According to some embodiments, the plurality of indexes may be used to organize the data in order to efficiently extract associations between features and the target variables. According to some embodiments, the probabilistic distributions may be formed by the machine learning algorithm trained on the data received in step 2202. According to some embodiments, the probabilistic distributions may represent a distribution of the performance likelihood of all manager entities of the organization. The probabilistic distributions may represent a distribution of all of the entities' performance at the organization, thereby showing how the entities' performance ranges across the workforce.

According to some embodiments, creating a distribution of manager performance for each of the plurality of positions, wherein the distribution uses a performance index for each entity of the plurality of entities. This distribution may help the system or the organization pinpoint characteristics that lead to a higher likelihood of entities departing the organization. From the distribution, a quantity of identified entities may be generated, where the quantity of identified entities have a performance score than a threshold manager performance probability in each of the plurality of positions over a duration of time. In this way, the system may predict a number of employees with a high probability of acting as good or bad managers the organization over a period of time. According to some embodiments, a characteristic manager performance probability metric may be extracted based on the quantified entities and the third index. The characteristic manager performance probability metric may be a metric or flag that identifies one or a set of characteristics from the initial data and the datasets. This one or more set of characteristics may be highly correlated with the likelihood of a number of entities acting as good or bad managers in the organization. The characteristic manager performance probability metric may be used to identify specific characteristics of the entities which raises concern regarding the entity's performance at the organization.

At step 2208, a manager performance threshold for the plurality of individuals in a manager role based on the plurality of indexes assigned to each of entities may be determined. The extracted associations from step 2206 and the characteristic manager performance probability metric may form the basis for calculating the manager performance threshold. The manager performance threshold may be the number or value associated with a set of data elements where the organization sees the lowest acceptable manager performance. For example, employees with more than five employee relation cases per quarter may be an unacceptable amount for the organization's internal goals; therefore, five employee relation cases may be the manager performance threshold associated with employee relation cases. The manager performance threshold may be a threshold value or number identified by the system and the machine learning algorithm that corresponds to an unacceptable performance of an entity acting as a manager in the organization.

For example, machine learning algorithm may serve as a manager performance algorithm, which may be used to determine a manager performance threshold for the plurality of individuals in a manager role. The non-transitory computer readable medium may include at least one processor that executes the manager performance algorithm to predict manager performance indexes of employees in a manager role. The manager performance algorithm assign a value or score to each variable of the plurality of variables. The manager performance algorithm may predict, using the plurality of indexes, a manager performance index for each entity of the plurality of entities. In this way, the machine learning algorithm utilizes the data from disparate sources to make predictions about the employees in managerial roles.

For example, when analyzing the data pertaining to organizational engagement for a plurality of employees in the same manager role, an employee who has a lower number of employee relation cases may result in a higher manager score than an employee who has a high number of employee relation cases.

At step 2210, the associations from step 2206 may be used by the machine learning algorithm to assign a manager performance index to each set of information included in the set of data elements. The manager performance index for the plurality of individuals in a manager role may be based on the plurality of indexes assigned to each set of information included in the set of data elements. The manager performance index may be associated with each individual employee.

At step 2210, the manager performance index of each of the plurality of individuals may be compared to the manager performance threshold. The comparison may compare the performance of a manager entity to the acceptable, or threshold, performance acceptable to the association. The operations may further include creating a distribution of manager performance indexes for the position, as described in connection to FIG. 10, wherein the distribution uses the manager performance index of each entity of the plurality of entities. The distribution may include the plurality of indexes. The operations may further include generating, using the distribution, a quantity of a projected plurality of entities in the position over a duration of time, thus describing the characteristics of the entities predicted to be in specific manager positions over time. The operations may further include generating a visualization of the distribution. The distribution may use the manager score of each of the plurality of individuals to illustrate how managers of different performances are predicted to advance through the ranks of the organization. The visualization may be displayed through a GUI or other interface such that the system or the organization can identify the progression of managers within the organization or identify managers performing below a threshold acceptability.

At step 2212, one or more entities associated with a manager performance indexes being higher than the manager performance threshold may be identified based on the comparison performed at step 2210. Manager performance indexes higher than the manager performance threshold may be systematically identified to calculate poor-performing managers to identify individuals who need additional training or to be let go from the organization. For example, low performing managers who present a high risk to the organization may be predicted based on the initial data. The extracted associations may offer predictions related to how frequently other entities are likely to leave the organization under specific managers. Therefore, a poorly performing manager may present a risk to the organization by loosing talent that would otherwise be beneficial to the organization.

At step 2214, one or more policy changes within the organization, based on the identification, may be implemented. For example, one or more policy changes may comprise a set of rules that are removed from the employee requirements. For example, the one or more changes to one or more policies may be configured to reduce the likelihood of a low performing manager continuing to perform poorly. For example, the one or more changes to one or more policies may include retraining an identified entity or removing an identified entity from the organization. For example, policy changes may include retraining an identified entity or manager to help the manager perform within the requirements of the organization.

These types of policy changes may include, for example, identifying skill gaps by assessing the current skills of employees and identifying areas where retraining is needed; monitoring training progress by ensuring that employees are successfully completing the retraining programs and gaining the necessary skills; keeping up with industry trends and advancements to ensure training programs are relevant; and ensuring compliance by making sure that any necessary certifications or regulatory requirements are met through training. Manager retraining may include, for example, leadership training, time management and productivity training, teaching communication skills, helps with team building and communication, conflict resolution techniques, inclusion training, financial management training, training to encourage employee engagement and motivation, and sales management training.

At step 2216, the manager performance index of one or more identified entities over a period of time may be monitored based on the one or more policy changes or retraining. For example, steps 2212 through 2216 may be repeated after a period of time elapses from when the policy changes of step 2214 where implemented. According to some embodiments, entities' manager performance indexes may be recalculated iteratively as time passes to monitor whether the policy changes improve the manager performance at the organization. For example, the monitoring may enable an organization to evaluate whether the changes implemented have improved the performance of the identified managers. According to some embodiments, monitoring may include constant, iterative, or repetitive collection of the data from the plurality of disparate data sources such that employee performance and retention may be improved. In this way, method 2200 may improve managerial quality, thereby improving employee retention and allowing an organization to tailor its policies to retain top talent and increase parity in its workforce.

FIG. 23 illustrates a flow chart 2300 showing the flow of initial data from a plurality of disparate data sources to calculate individuals whose performance scores necessitate a second, objective review.

At step 2302, data may be received from a plurality of disparate data sources. The data may include a plurality of variables, wherein each variable of the plurality of variables is associated with a data type and an entity of a plurality of entities in a position. The plurality of variables may include performance markers associated with each employee. Performance markers may be indicators or traits in the plurality of indexes which correlate to strong performance and productivity in the organization. Performance markers may include: an employee consistently meeting or exceeding individual and team targets, which demonstrates effectiveness and dedication; an employee producing high-quality work with attention to detail, accuracy, and creativity, which reflects commitment and skill; an employee suggesting improvements or taking on additional responsibilities, which shows engagement and leadership potential; an employee contributing to team projects or supporting colleagues; an employee pursuing professional development opportunities or seeking feedback; and an employee prioritizing tasks effectively and meeting deadlines consistently, which reflects strong organizational skills.

For example, the data may include the data including a first, second, third, and fourth plurality of variables. Each of the first plurality of variables may be associated with one entity of a plurality of entities in a position of a plurality of positions. For example, the first plurality of variables may include information about each of the entities in a managerial position, including, for example, each entity's demographic information, each entity's organizational engagement, each entity's team engagement, each entity's tenure with the organization, and other information regarding each entity, as described above. According to some embodiments, the plurality of positions may include one or more employment or levels within the organization. For example, some positions may include any level of manager, legal managers, and senior executive. Each of the second plurality of variables may be associated with a performance metric of a plurality of performance metrics associated with the each of the plurality of entities. For example, the second plurality of variables may include each entity's performance scores as predicted through associations, described below, obtained by monitoring an entity, and other data associated with an entity's job performance, as described above. The initial data may include information associated with employee peer-to-peer recognition, manager-to-employee recognition, an employee's outstanding equity in the organization, changes in management above the employee, and organizational risk factors. For example, employee peer-to-peer recognition may include the business practice of colleagues acknowledging and appreciating each other's contributions, efforts, and achievements in the workplace. Employee peer-to-peer recognition may include structured business initiatives that encourage employees to recognize one another through platforms or tools designed for the purpose. Employee peer-to-peer recognition data may be associated with an individual employee who performs at an above-average level compared to their peers. An individual employee who performs at an above-average level compared to their peers and is recognized through the employee peer-to-peer recognition system may be expected to receive positive performance scores.

Each of the third plurality of variables may be associated with one or more review scores associated with each of the plurality of entities. For example, the second plurality of variables may include each entity's performance scores as assigned by a manager review.

Each of the fourth plurality of variables may be associated with one or more demographic qualities of each of the plurality of entities. For example, the fourth plurality of variables may include each entity's demographic information.

The plurality of disparate data sources includes at least one of: one or more input datasets, one or more second input datasets, and individual and group performance monitoring, as discussed above with respect to FIG. 21.

At step 2304, the data may be distilled into a plurality of indexes. The distilling may convert the data into a plurality of indexes to be usable by a single data structure. The distilling may convert the data into a plurality of indexes to be usable by a single data structure. The data conversion may be performed by assigning a binary value to each variable of the plurality of variables, wherein each variable is a categorical value, a numerical value, or an ordinal value, by generating, using the binary value of each variable, an index for each data type and each entity of the plurality of entities and by storing each index in a database.

The distilling may comprise generating a plurality of indexes, where the plurality of indexes comprises: a first index associated with the plurality of entities; a second index associated with the plurality of performance metrics; a third index associated with the one or more review scores; and a fourth index associated with the one or more characteristics associated with each of the plurality of entities. The indexes may be stored in a database. The indexes may function in the same way as those described above with respect to FIG. 21.

At step 2306, a plurality of entities and their associated performance metrics may be compared. For example, the first index and the second index are compared for each of the entities. In this way, the entities performance may be compared to one another to identify one or more entities having a higher performance than their peers.

At step 2308, one or more associations may be extracted from the comparison and the plurality of indexes associated with a plurality of individuals in a job role, for example, in the same manner using a machine learning algorithm as described with respect to FIGS. 21 and 22. For example, associations pertaining to information associated with at least one of employee peer-to-peer recognition, manager-to-employee recognition, an employee's outstanding equity in the organization, changes in management above the employee, and organizational risk factors may be retrieved from the plurality of indexes associated with a plurality of individuals in a job role.

According to some embodiments, extracting the one or more associations may include identifying one or more indicia related to the at least one of: one or more input datasets, one or more second input datasets, individual performance monitoring, team monitoring, and market monitoring; and wherein the one or more indicia are associated historical conditions related to underrepresented entities within the organization. The one or more indicia may be signals or flags, which have a high correlation between a characteristic of an entity and the likelihood of the associated entity having a mismatch between their actual performance, or their probabilistic performance score, and the review assigned by their manager. For example, the one or more indicia may mark or indicate certain conditions or categories in the input datasets. The indicia may be identified by the machine learning algorithm based on predicted relationships or patterns in the data.

At step 2310, a probabilistic performance score may be associated with each of the plurality of entities. For example, a set of one or more associations may be extracted from the plurality of indexes. Each of the one or more associations may include one or more probabilistic distributions based on the relationship between each of the plurality of performance metrics and each of the plurality of managerial positions. According to some embodiments, the probabilistic distributions may be formed by a machine learning algorithm trained on the data acquired in step 2302, or from historical data relating to managerial performance, or both.

For example, the associations may be based on a probabilistic performance score associated with each of the one or more entities. The probabilistic performance score may be extracted from the one or more associations. The probabilistic performance score may relate to an entities projected performance score as predicted by a machine learning algorithm, for example, as described above with respect to FIGS. 21 and 22. The probabilistic performance score for the plurality of individuals in a job role may be based on the plurality of indexes associated with the plurality of individuals in a job role. The probabilistic performance score may be associated with each individual employee. The probabilistic performance score may include performance markers for employees. Performance markers may be indicators or traits in the plurality of indexes which correlate to strong performance and productivity in the organization. Performance markers may include: an employee consistently meeting or exceeding individual and team targets, which demonstrates effectiveness and dedication; an employee producing high-quality work with attention to detail, accuracy, and creativity, which reflects commitment and skill; an employee suggesting improvements or taking on additional responsibilities, which shows engagement and leadership potential; an employee contributing to team projects or supporting colleagues; an employee pursuing professional development opportunities or seeking feedback; and an employee prioritizing tasks effectively and meeting deadlines consistently, which reflect strong organizational skills.

At step 2312, one or more entities having a probabilistic performance score higher than the same one or more entities' review score may be identified. According to some embodiments, a review score may be assigned to each set of information included in the initial data. For example, a review score may include formal reviews submitted by a manager for each of their employees in the same job role. The review score may be associated with each individual employee.

The machine learning algorithm may include a score discrepancy algorithm which may be used to determine a discrepancy between an entity's probabilistic performance score and the same entity's review score.

At step 2314, an organization may determine a performance discrepancy threshold based on the identification in step 2312. For example, slight variations in the probabilistic performance score and the review score may be acceptable calculation error. The performance discrepancy threshold may be the number or value associated with a set of data elements where the organization is predicted to have the most detrimental effect of the promotion and performance of an entity at the organization. For example, a small discrepancy between an employee's probabilistic performance score and the same employee's review may not be the score discrepancy threshold if the organization determines that the margin of error in a review is acceptable. For example, an employee who is facing bias or discrimination from their manager might have a review score that is significantly lower than their probabilistic performance score, which may result in a discrepancy higher than the performance discrepancy threshold. In accordance with embodiments of the present disclosure, this employee may be flagged for a second, objective review to evaluate the employee without the bias or discrimination from their reviewing manager.

At step 2316, the machine learning algorithm may predict entities having a probabilistic performance score being higher than the same entity's review score. At step 2316, the to the machine learning algorithm may determine a score discrepancy for each of the plurality of individuals in a job role to predict score discrepancy of employees in that job role.

The operations may further include creating a distribution of performance discrepancy scores for the position, as described in connection to FIG. 10, wherein the distribution uses the performance discrepancy score of each entity of the plurality of entities. The distribution may include the plurality of indexes. The operations may further include generating, using the distribution, a quantity of a projected plurality of entities in the position over a duration of time. The operations may further include generating a visualization of the distribution. The distribution may use the performance discrepancy score of each of the plurality of individuals. The operations may further comprise generating, using the distribution, a quantity of a projected plurality of entities in the position over a duration of time. The operations may further comprise generating a visualization of the distribution. Performance discrepancy score scores greater than the score discrepancy threshold may be systematically identified to score discrepancy in the organization or to flag individuals who require a second, object review. This visualization may allow the system or the organization to identify or distill entities having shared characteristics who face similar amounts of score discrepancy between their respective probabilistic performance score and their manager review score.

At step 2318, the identified entities may be assigned an objective second review. The objective second review may include a review by an impartial manager, or a review based solely on performance metrics. The objective second review may remove the potential bias from the manager review and provide the employee with more opportunities at the organization. The objective second review may allow employees with less crucial work assignments to be reassigned to higher priority work based on their performance scores.

At step 2320, one or more policy changes within the organization, based on the identification, may be implemented. For example, the one or more changes to one or more policies may be configured to reduce the likelihood of an entity having a high probabilistic performance score remaining under the supervision of a biased manager. For example, the one or more changes to one or more policies may include retraining a biased manager or removing a biased manager from the organization.

At step 2322, the score discrepancy of one or more identified entities over a period of time may be monitored based on one or more policy changes or based on the objective second review for the plurality of identified entities. For example, steps 2316 through 2320 may be repeated after a period of time elapses from when the policy changes of step 2320 where implemented. According to some embodiments, entities' probabilistic performance score may be recalculated iteratively as time passes to monitor whether the policy changes improve the likelihood the entity's manager review score matching their probabilistic performance score within an acceptable error tolerance.

In this way, method 2322 improve review quality, leading to more accurate evaluation of employees and thereby improving employee retention and allowing an organization to tailor its policies to retain top talent and increase parity in its workforce.

The disclosed embodiments are not limited to the above-described examples, but instead are defined by the appended claims in light of their full scope of equivalents. Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

It is intended, therefore, that the specification and examples be considered as example only, with a true scope and spirit being indicated by the following claims and their full scope of equivalents.

1.-39. (canceled)

40. A non-transitory computer readable medium storing instructions that, when executed by a processor, cause the processor to perform operations comprising:
receiving data from a plurality of disparate data sources, the data including a first, second, third, and fourth plurality of variables,
wherein each of the first plurality of variables is associated with one entity of a plurality of entities in a position of a plurality of positions;
wherein each of the second plurality of variables is associated with a performance metric of a plurality of performance metrics associated with the each of the plurality of entities;
wherein each of the third plurality of variables is associated with one or more review scores associated with each of the plurality of entities;
wherein each of the fourth plurality of variables is associated with one or more characteristics of each of the plurality of entities; and
wherein the plurality of disparate data sources includes at least one of: one or more input datasets, one or more second input datasets, and individual and group performance monitoring;
generating a plurality of indexes, where the plurality of indexes includes:
a first index associated with the plurality of entities;
a second index associated with the plurality of performance metrics;
a third index associated with the one or more review scores; and
a fourth index associated with the one or more characteristics associated with each of the plurality of entities;
storing the plurality of indexes in a database;
comparing the first index and second index for each of the plurality of entities;
extracting one or more associations from the plurality of indexes, wherein each of the one or more associations includes one or more probabilistic distributions based on a relationship between the plurality of indexes,
wherein the one or more associations are related to a probabilistic performance score associated with each of the one or more entities;
identifying, based on the extraction and the comparison, that the probabilistic performance score associated with an entity of the one or more entities is higher than the review score associated with the entity;
implementing, based on the identification, one or more changes to one or more policies of an organization,
wherein the one or more changes to one or more policies are configured to reduce a statistical likelihood that the associated one or more entities will have a mismatched review score and probabilistic review score;
monitoring, based on the implementation, the probabilistic review score of the associated one or more entities over a period of time; and
distilling, based on the identification and the fourth index, common characteristics shared among the associated one or more entities.

41. The non-transitory computer readable medium of claim 40, wherein the generating the plurality of indexes further includes:
identifying one or more indicia related to at least one of: one or more input datasets, one or more second input datasets, individual performance monitoring, team monitoring, and market monitoring; and
wherein the one or more indicia are associated historical conditions related to underrepresented entities in an organization.

42. The non-transitory computer readable medium of claim 40, the operations further comprising:
creating a distribution of the probabilistic performance score for a manager associated with each of the entities;
generating, using the distribution, a quantity of a projected plurality of entities in an associated position over a duration of time; and
identifying, based on the generation and the projected plurality of entities, one or more managers acting with unfair bias towards their associated reporting entities.

43. The non-transitory computer readable medium of claim 42, the operations further comprising generating a visualization of the distribution.

44. The non-transitory computer readable medium of claim 40, wherein the performance metrics are associated with one or more of: peer reviews, peer recognition, objective performance criteria, productivity levels, employee involvement with an organization, years of service with the organization, assigned responsibilities, task ownership, and task oversight.

45. A method comprising:
receiving data from a plurality of disparate data sources, the data including a first, second, third, and fourth plurality of variables,
wherein each of the first plurality of variables is associated with one entity of a plurality of entities in a position of a plurality of positions;
wherein each of the second plurality of variables is associated with a performance metric of a plurality of performance metrics associated with the each of the plurality of entities;
wherein each of the third plurality of variables is associated with one or more review scores associated with each of the plurality of entities;
wherein each of the fourth plurality of variables is associated with one or more characteristics of each of the plurality of entities; and
wherein the plurality of disparate data sources includes at least one of: one or more input datasets, one or more second input datasets, individual performance monitoring, team monitoring, and market monitoring;
generating a plurality of indexes, where the plurality of indexes includes:
a first index associated with the plurality of entities;
a second index associated with the plurality of performance metrics;
a third index associated with the one or more review scores; and
a fourth index associated with the one or more characteristics associated with each of the plurality of entities;
storing the plurality of indexes in a database;
comparing the first index and second index for each of the plurality of entities;
extracting one or more associations from the plurality of indexes, wherein each of the one or more associations includes one or more probabilistic distributions based on a relationship between the plurality of indexes,
wherein the one or more associations are related to a probabilistic performance score associated with each of the one or more entities;
identifying, based on the extraction and the comparison, that the probabilistic performance score associated with an entity of the one or more entities is higher than the review score associated with the entity;
implementing, based on the identification, one or more changes to one or more policies of an organization,
wherein the one or more changes to one or more policies are configured to reduce a statistical likelihood that the associated one or more entities will have a mismatched review score and probabilistic review score;
monitoring, based on the implementation, the probabilistic review score of the associated one or more entities over a period of time; and
distilling, based on the identification and the fourth index, common characteristics shared among the associated one or more entities.

46. The method of claim 45, wherein the generating the plurality of indexes further includes:
identifying one or more indicia related to at least one of: one or more input datasets, one or more second input datasets, individual performance monitoring, team monitoring, and market monitoring; and
wherein the one or more indicia are associated historical conditions related to underrepresented entities in an organization.

47. The method of claim 45, further comprising:
creating a distribution of the probabilistic performance score for a manager associated with each of the entities;
generating, using the distribution, a quantity of a projected plurality of entities in an associated position over a duration of time; and
identifying, based on the generation and the projected plurality of entities, one or more managers acting with unfair bias towards their associated reporting entities.

48. The method of claim 46, further comprising generating a visualization of the distribution.

49. The method of claim 45, wherein the performance metrics are associated with one or more of: peer reviews, peer recognition, objective performance criteria, productivity levels, employee involvement with an organization, years of service with the organization, assigned responsibilities, task ownership, and task oversight.

50. A system comprising:
a memory storing instructions; and
a processor configured to execute the stored instructions to:
receive data from a plurality of disparate data sources, the data including a first, second, third, and fourth plurality of variables,
wherein each of the first plurality of variables is associated with one entity of a plurality of entities in a position of a plurality of positions;
wherein each of the second plurality of variables is associated with a performance metric of a plurality of performance metrics associated with the each of the plurality of entities;
wherein each of the third plurality of variables is associated with one or more review scores associated with each of the plurality of entities;
wherein each of the fourth plurality of variables is associated with one or more characteristics of each of the plurality of entities; and
wherein the plurality of disparate data sources includes at least one of: one or more input datasets, one or more second input datasets, individual performance monitoring, team monitoring, and market monitoring;
generate a plurality of indexes, where the plurality of indexes includes:
a first index associated with the plurality of entities;
a second index associated with the plurality of performance metrics;
a third index associated with the one or more review scores; and
a fourth index associated with the one or more characteristics associated with each of the plurality of entities;
store the plurality of indexes in a database;
compare the first index and second index for each of the plurality of entities;
extract one or more associations from the plurality of indexes, wherein each of the one or more associations includes one or more probabilistic distributions based on a relationship between the plurality of indexes,
wherein the one or more associations are related to a probabilistic performance score associated with each of the one or more entities;
identify, based on the extraction and the comparison, that the probabilistic performance score associated with an entity of the one or more entities is higher than the review score associated with the entity;
implement, based on the identification, one or more changes to one or more policies of an organization,
wherein the one or more changes to one or more policies are configured to reduce a statistical likelihood that the associated one or more entities will have a mismatched review score and probabilistic review score;
monitor, based on the implementation, the probabilistic review score of the associated one or more entities over a period of time; and
distill, based on the identification and the fourth index, common characteristics shared among the associated one or more entities.

51. The system of claim 50, wherein the generation of the plurality of indexes further includes:
identifying one or more indicia related to at least one of: one or more input datasets, one or more second input datasets, individual performance monitoring, team monitoring, and market monitoring; and
wherein the one or more indicia are associated historical conditions related to underrepresented entities in an organization.

52. The system of claim 50, wherein the processor is further configured to:
create a distribution of the probabilistic performance score for a manager associated with each of the entities; and
generate, using the distribution, a quantity of a projected plurality of entities in an associated position over a duration of time; and
identify, based on the generation and the projected plurality of entities, one or more managers acting with unfair bias towards their associated reporting entities.

53. The system of claim 52, wherein the processor is further configured to generate a visualization of the distribution.

54. The system of claim 50, wherein the performance metrics are associated with one or more of: peer reviews, peer recognition, objective performance criteria, productivity levels, employee involvement with an organization, years of service with the organization, assigned responsibilities, task ownership, and task oversight.
